(19) United States
(12) Patent Application Publication
(10) Pub. No.: US 2026/0170614 A1
(43) Pub. Date: Jun. 18, 2026

(54) PROCESSING CONTROL METHOD AND APPARATUS, AND DEVICE

(71) Applicant: MAKEBLOCK CO., LTD., Shenzhen (CN)

(72) Inventors: Yuanxiu ZHANG, Shenzhen (CN); Lu ZHANG, Shenzhen (CN); Sen TONG, Shenzhen (CN); Qing WEN, Shenzhen (CN)

(73) Assignee: MAKEBLOCK CO., LTD., Shenzhen (CN)

(21) Appl. No.: 19/533,175

(22) Filed: Feb. 7, 2026

Related U.S. Application Data
(63) Continuation-in-part of application No. 18/705,198.

(30) Foreign Application Priority Data
Oct. 26, 2021 (CN) 202111249139.6
Oct. 26, 2021 (CN) 202111250792.4
Aug. 13, 2025 (CN) 202511134656.7

(51) Int. Cl. G06T 5/50; G06T 7/60; G06T 7/70; G06V 10/74

(52) U.S. Cl. CPC G06T 5/50; G06T 7/60; G06T 7/70; G06V 10/761; G06T 2207/20221

(57) ABSTRACT

The present disclosure provides a processing control method, device, system, and medium. The method comprises: obtaining a captured image of a processing platform on which at least one carrier is placed; determining a seed processing pattern; determining a target shape; determining at least one target carrier in the captured image that matches the target shape; and superimposing a target processing pattern on the at least one target carrier based on the seed processing pattern.

### CROSS-REFERENCE TO RELATED APPLICATIONS

This application is a continuation-in-part of national phase U.S. patent application Ser. No. 18/705,198 filed on Apr. 26, 2024, which claims priority to International Application No. PCT/CN 2022/116325 filed on Aug. 31, 2022, which claims priority to Chinese Patent Application No. 202111249139.6 filed on Oct. 26, 2021, and Chinese Patent Application No. 202111250792.4 filed on Oct. 26, 2021, and this continuation-in-part application also claims priority to Chinese Patent Application No. 202511134656.7 filed on Aug. 13, 2025, the entireties of which are incorporated herein by reference.

### FIELD

The present disclosure relates to the technical field of processing, and in particular to a processing control method, a processing device, a system and a computer-readable storage medium.

### BACKGROUND

Processing devices, such as desktop 3D printing devices as a user-level 3D printing solution, and other subtractive processing devices like laser cutting and engraving devices, are increasingly used to meet people's entertainment and other daily needs, and are used by growing number of individuals and families. Users can use a desktop 3D printing device or other subtractive processing devices to process carriers to obtain finished products that combine specific patterns with specific carrier shapes.

### SUMMARY

The purpose of the present disclosure is to provide a processing control method, a processing device, and a computer-readable storage medium, which can improve the processing efficiency of carriers to be processed.

According to a first aspect of the present disclosure, a processing control method is provided, including: obtaining a captured image of a processing platform on which at least one carrier is placed; determining a seed processing pattern; determining a target shape; determining at least one target carrier in the captured image that matches the target shape; and superimposing a target processing pattern on the at least one target carrier based on the seed processing pattern.

According to a second aspect of the present disclosure, a processing device is provided, the processing device including: a processing platform for placing at least one carrier; a camera for capturing an image of the at least one carrier placed on the processing platform; and a controller configured to: determine a seed processing pattern; determine a target shape; determine at least one target carrier in the captured image that matches the target shape; and superimpose a target processing pattern on the at least one target carrier based on the seed processing pattern.

According to a third aspect of the present disclosure, a system is provided, including: at least one processor; at least one non-volatile computer-readable storage medium; and program instructions stored on the non-volatile computer-readable storage medium and executable by the processor, enabling the system to: obtain a captured image of a processing platform on which at least one carrier is placed; determine a seed processing pattern; determine a target shape; determine at least one target carrier in the captured image that matches the target shape; and superimpose a target processing pattern on the at least one target carrier based on the seed processing pattern.

According to a fourth aspect of the present disclosure, a non-volatile computer-readable storage medium is provided, including a program that, when executed by a processor, causes the processor to perform: obtaining a captured image of a processing platform on which at least one carrier is placed; determining a seed processing pattern; determining a target shape; determining at least one target carrier in the captured image that matches the target shape; and superimposing a target processing pattern on the at least one target carrier based on the seed processing pattern.

### BRIEF DESCRIPTION OF THE DRAWINGS

The drawings, which are incorporated in and constitute a part of this specification, illustrate embodiments consistent with the present disclosure and are used to explain the principles of the present disclosure together with the description. Apparently, the drawings used in the following description show merely some embodiments of the present disclosure, and those skilled in the art can obtain other drawings based on these drawings without creative efforts.

FIG. 1 illustrates a schematic flowchart of a processing control method according to an embodiment of the present disclosure;

FIG. 2 illustrates a schematic diagram of processing control according to an embodiment of the present disclosure;

FIG. 3 illustrates a schematic flowchart of a method for obtaining pixel distributions according to an embodiment of the present disclosure;

FIG. 4 illustrates a schematic diagram of obtaining pixel distributions according to an embodiment of the present disclosure;

FIG. 5 illustrates a schematic diagram of a process for determining a target carrier according to an embodiment of the present disclosure;

FIG. 6 illustrates a schematic diagram of similarity matching according to an embodiment of the present disclosure;

FIG. 7 illustrates a schematic diagram of overlapping between carriers and modified seed carriers according to an embodiment of the present disclosure;

FIG. 8 illustrates a schematic structural diagram of a processing control apparatus according to an embodiment of the present disclosure; and

FIG. 9 illustrates a schematic structural diagram of a processing device according to another embodiment of the present disclosure.

FIG. 10A is a schematic diagram of an implementation environment involved in the present disclosure;

FIG. 10B schematically shows a structural block diagram of a processing device applying the technical solution of the present disclosure;

FIG. 11 is a flowchart of a processing control method according to an exemplary embodiment of the present disclosure;

FIG. 12A is a schematic diagram of a seed processing pattern according to an exemplary embodiment of the present disclosure;

FIG. 12B is a schematic diagram of a target processing pattern according to an exemplary embodiment of the present disclosure;

FIG. 13A is a schematic diagram of a seed processing pattern according to an exemplary embodiment of the present disclosure;

FIG. 13B is a schematic diagram of an object to be modified according to an exemplary embodiment of the present disclosure;

FIG. 13C is a schematic diagram of a replacement object according to an exemplary embodiment of the present disclosure;

FIG. 13D is another schematic diagram of a replacement object according to an exemplary embodiment of the present disclosure;

FIG. 13E is a schematic diagram of a pop-up page according to an exemplary embodiment of the present disclosure;

FIG. 14 is an application schematic diagram of determining an object to be modified in a seed processing pattern according to an exemplary embodiment of the present disclosure;

FIG. 15 is an application schematic diagram of importing a candidate object document according to an exemplary embodiment of the present disclosure;

FIG. 16 is an application schematic diagram of importing a candidate object document according to another exemplary embodiment of the present disclosure;

FIG. 17 is a flowchart of a method for controlling a processing device to perform batch processing on at least two carriers to be processed according to at least two target processing patterns in step S2240 in the embodiment shown in FIG. 11;

FIG. 18 is a flowchart of a method for superimposing a target processing pattern according to another exemplary embodiment of the present disclosure;

FIG. 19 is a flowchart of a method for obtaining a close-up image obtained by close-up shooting on a target carrier to be processed according to an exemplary embodiment of the present disclosure;

FIG. 20 is a flowchart of a method for superimposing at least two target processing patterns into respective processing regions corresponding to respective target carriers to be processed in a close-up image according to an exemplary embodiment of the present disclosure;

FIG. 21A is an application schematic diagram of superimposing a target processing pattern in a close-up image according to an exemplary embodiment of the present disclosure;

FIG. 21B is a schematic diagram of an image acquisition planning path according to an exemplary embodiment of the present disclosure;

FIG. 22 is an application schematic diagram of batch processing by a processing device according to an exemplary embodiment of the present disclosure;

FIG. 23 is a schematic structural diagram of a processing control apparatus according to an exemplary embodiment of the present disclosure;

FIG. 24 shows a schematic structural diagram of a computer system applicable for implementing a terminal device according to an embodiment of the present disclosure;

FIG. 25 shows a flowchart of a processing control method according to an exemplary embodiment of the present disclosure; and

FIG. 26 shows a block diagram of a processing device according to an exemplary embodiment of the present disclosure.

### DETAILED DESCRIPTION

The technical solutions according to the embodiments of the present application are described clearly and completely as follows in conjunction with the drawings. It is apparent that the described embodiments are only a few rather than all of the embodiments according to the present application. All other embodiments acquired by those skilled in the art based on the embodiments of the present disclosure without any creative effort shall fall into the protection scope of the present disclosure.

In addition, the described characteristics, structures, or features may be combined in one or more embodiments in any appropriate manner. In the following descriptions, a lot of specific details are provided to give a comprehensive understanding of the embodiments of the present disclosure. However, those skilled in the art are to be aware that, the technical solutions in the present disclosure may be implemented without one or more of the particular details, or another method, unit, device, or step may be used. In other cases, well-known methods, devices, implementations, or operations are not shown or described in detail, in order to avoid obscuring aspects of the present disclosure.

The block diagrams in the drawings show merely functional entities and do not necessarily correspond to physically independent entities. In other words, such functional entities may be implemented in the form of software, or implemented in one or more hardware modules or integrated circuits, or implemented in different networks and/or processor apparatus and/or microcontroller apparatus.

The flowcharts shown in the drawings are merely for exemplary descriptions and do not necessarily include all of the content and operations/steps, nor are they necessarily performed in the sequence described. For example, some operations/steps may be further divided, and some operations/steps may be combined or partially combined. Therefore, an actual execution sequence may be changed according to an actual situation.

In the description of the present disclosure, the terms “first” and “second” are used for descriptive purposes only, and should not be understood as indicating or implying relative importance or implicitly indicating the number of indicated technical features. Therefore, the feature defined by “first” and “second” may explicitly or implicitly be one or more in number. In addition, in the description of the present application, “multiple or a plurality of” means two or more unless otherwise stated.

The term “and/or” describes the association relationship of associated objects, indicating that there may be three relationships. For example, “A and/or B” may mean: A exists alone, A and B exist simultaneously, or B exists alone. The character “/” generally indicates that the preceding and following objects are in an “or” relationship.

The following is an introduction and explanation of several terms involved in the present disclosure:

Upper-level device: Refers to a terminal device installed with application programs, such as a computer, tablet computer, or mobile phone.

Lower-level device: Refers to a processing device or processing tool, including laser engraving machines, laser cutting machines, cutting machines, printers, etc.

Seed processing pattern: Also referred to as an initial processing pattern; an original template composed of at least one processing object in a current editable interface. The processing object is a processing element in the seed processing pattern.

Object to be modified: Refers to a variable object that can be modified, determined from a plurality of processing objects included in the seed processing pattern.

Replacement object: Refers to an object associated with the object to be modified. The replacement object is used to replace or cover the object to be modified in the seed processing pattern.

Item to be processed, or alternatively referred to as a carrier to be processed, or a carrier: Refers to a material placed in the processing region of the lower-level device, i.e., the processing device, to be formed with patterns.

Target processing pattern, or alternatively referred to as an image to be processed: Refers to a pattern intended to be formed on a carrier. In some embodiments, the target processing pattern is an acquired seed processing pattern. In other embodiments, the target processing pattern may be a pattern similar to the seed processing pattern, obtained based on the seed processing pattern by replacing the object to be modified in the seed processing pattern with a replacement object.

Editable interface: An interface of an application program used with processing devices, integrating design, editing, and machine control functions. The application program can be installed on user terminals such as computers, tablet computers, or mobile phones to facilitate users'creation and processing.

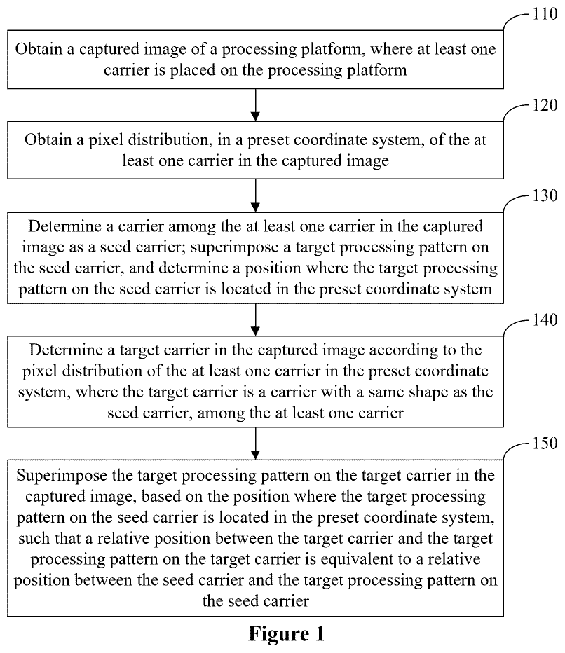

As shown in FIG. 1, the method at least includes the following steps from step 110 to step 150.

In step 110, a captured image of a processing platform is obtained, where at least one carrier is placed on the processing platform.

The carriers are processing materials to be cut or engraved, which are in different shapes and sizes, such as the shape of a trapezoid, a circle and a triangle. The carriers are placed on the processing platform manually or by mechanical arms, and the carriers are located on the processing platform dispersedly.

In step 120, a pixel distribution, in a preset coordinate system, of the at least one carrier in the captured image is obtained.

The pixel distribution of the carrier in the preset coordinate system indicates the position and pixel value of each pixel point of the carrier in the preset coordinate system. It is noted that the position of the carrier in the captured image forms a mapping relationship with the position of the carrier on the processing platform, and the position of the carrier on the processing platform can be determined by determining the pixel distribution of the carrier in the captured image in the preset coordinate system.

In step 130, a carrier in the captured image is determined as a seed carrier; a target processing pattern is superimposed on the seed carrier, and a position where the target processing pattern on the seed carrier is located in the preset coordinate system is determined.

The target processing pattern is the pattern of a finished product obtained by cutting or engraving the carriers. For example, if the user wishes to get a gear by processing, the target processing pattern is the shape of the gear. In a specific implementation, the captured image, that is, the target processing pattern, can be displayed in an image interaction interface, and the user can drag, in the image interaction interface, the target processing pattern onto a carrier in the captured image, and in this case the carrier being superimposed with the target processing pattern is the seed carrier.

In step 140, a target carrier in the captured image is determined according to the pixel distribution of the at least one carrier in the preset coordinate system, where the target carrier is a carrier with the same shape as the seed carrier, among the at least one carrier.

The target carrier is the carrier to be cut or engraved with the target processing pattern. It should be noted that the target carrier has the same shape as the seed carrier, but may have a size different from the seed carrier. The carrier with characteristics similar to the seed carrier is determined as the target carrier, based on the pixel distribution of all the carriers in the preset coordinate system.

In step 150, the target processing pattern is superimposed on the target carrier, based on the position where the target processing pattern on the seed carrier is located in the preset coordinate system, such that a relative position between the target carrier and the target processing pattern on the target carrier is equivalent to a relative position between the seed carrier and the target processing pattern on the seed carrier.

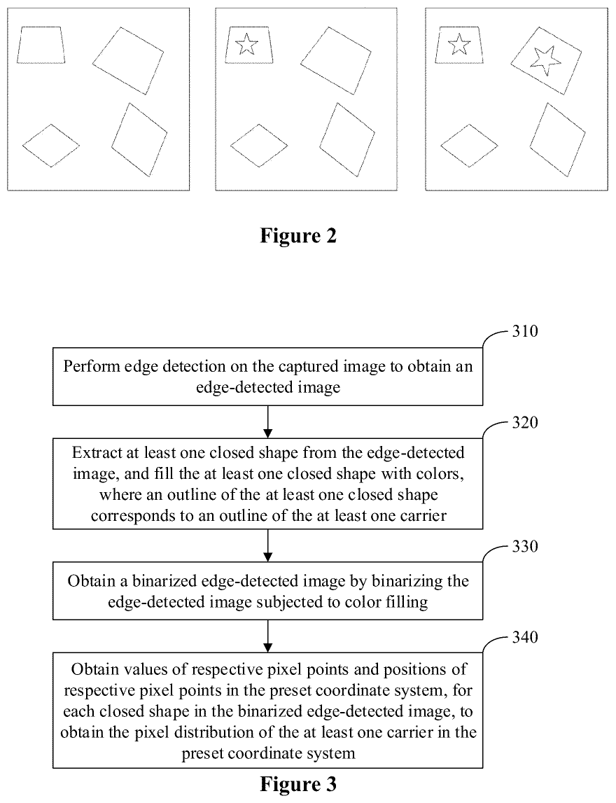

As shown in FIG. 2, the left picture shows the captured image which includes multiple carriers, and the carriers are trapezoidal and rhombic; the middle picture shows the image with the target processing pattern dragged to the seed carrier in the captured image, the target processing pattern is a five-pointed star, and the five-pointed star is superimposed on a trapezoidal carrier; the right picture shows the image with copies of the target processing pattern superimposed on all the target carriers in the captured image, i.e., copies of the five-pointed star is superimposed on all the trapezoidal carriers.

It should be noted that there may be seed carriers of various shapes, and there may be one or more target processing patterns. For example, both the trapezoidal carrier and the triangular carrier are seed carriers, and the target processing pattern on the trapezoidal carrier is a five-pointed star, the target processing pattern on the triangular carrier is a four-pointed star. In the present disclosure, the five-pointed star can be superimposed on other trapezoidal carriers, and the four-pointed star can be superimposed on other triangular carriers.

In the embodiments of the disclosure, by identifying the shape and pixel distribution of all carriers on the processing platform, the target processing pattern is copied to the target carrier with the same shape as the seed carrier, so that the carriers with the same shape can be processed in batches by using the target processing pattern, and user experience is improved.

As shown in FIG. 3, the method at least includes the following steps from step 310 to step 340.

In step 310, edge detection is performed on the captured image to obtain an edge-detected image.

The carriers have a color contrast with respect to the processing platform, so the edge-detected image is obtained based on the color contrast between the carries and the background in the captured image, the edge-detected image includes the outline of each carrier, that is, each closed shape.

In step 320, at least one closed shape in the edge-detected image is extracted, and color filling is performed for the at least one closed shape, where the outline of the closed shape corresponds to the outline of the carrier.

In step 330, a binarized edge-detected image is obtained by binarizing the edge-detected image subjected to color filling.

The binarization process converts the value of the pixels in the image to 0 or 255, that is, being displayed as black or white, so after the binarization process, the color of the pixels in the closed shape is black, and the color of the pixels outside the closed shape is white.

In step 340, values of respective pixel points and positions of respective pixel points in the preset coordinate system are obtained for each closed shape in the binarized edge-detected image, to obtain the pixel distribution of the at least one carrier in the preset coordinate system.

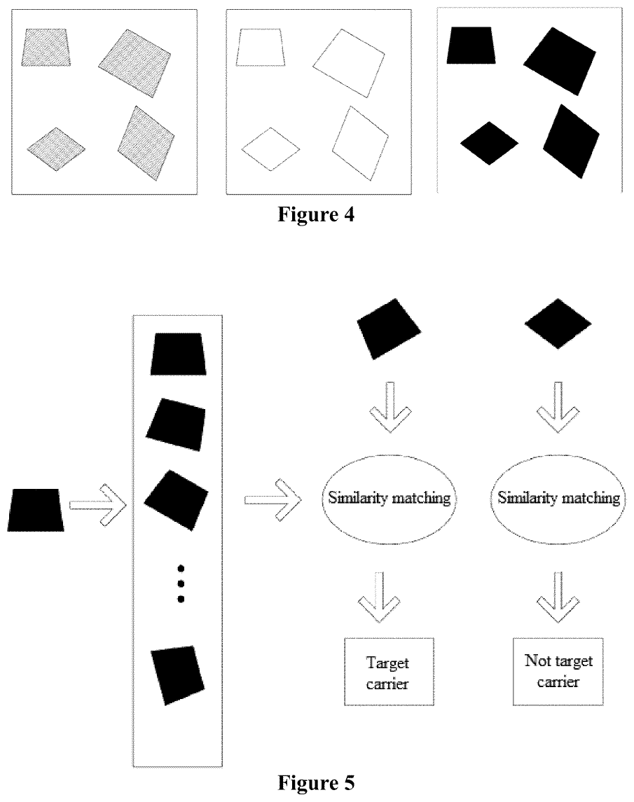

As shown in FIG. 4, the captured image is on the left, the edge-detected image is in the middle, and the binarized image is on the right.

In the embodiment of the present disclosure, the positions and pixel values of pixels of the carriers in the preset coordinate system are determined through edge detection and binarization processing, for subsequently determining the target carrier.

In some embodiments of the present disclosure, based on the above scheme, determining the target carrier in the captured image according to the pixel distribution of the at least one carrier in the preset coordinate system includes:
generating pixel distributions of modified seed carriers in the preset coordinate system based on the pixel distribution of the seed carrier in the preset coordinate system, where the modified seed carriers are obtained by rotating the seed carrier by a set of preset angles;
performing a similarity matching between the at least one carrier and the modified seed carriers based on the pixel distribution of the at least one carrier and the pixel distributions of the modified seed carriers in the preset coordinate system, to determine the target carrier in the captured image.

In a specific implementation, the set of preset angles is [0, 1, 2, 3 . . . 358, 359], and the modified seed carriers are obtained by rotating the seed carrier by 0 to 359 degrees. It may be determined whether the carrier is the target carrier and the rotation angle of the carrier relative to the seed carrier by performing the similarity matching between the carriers in the captured image and a set of modified seed carriers.

As shown in FIG. 5, the trapezoidal carrier is used as the seed carrier and rotated from 1 to 359 degrees to form the set of modified seed carriers, and similarity matching is performed for each carrier in the captured image with the modified seed carriers one by one to determine whether the carrier is the target carrier.

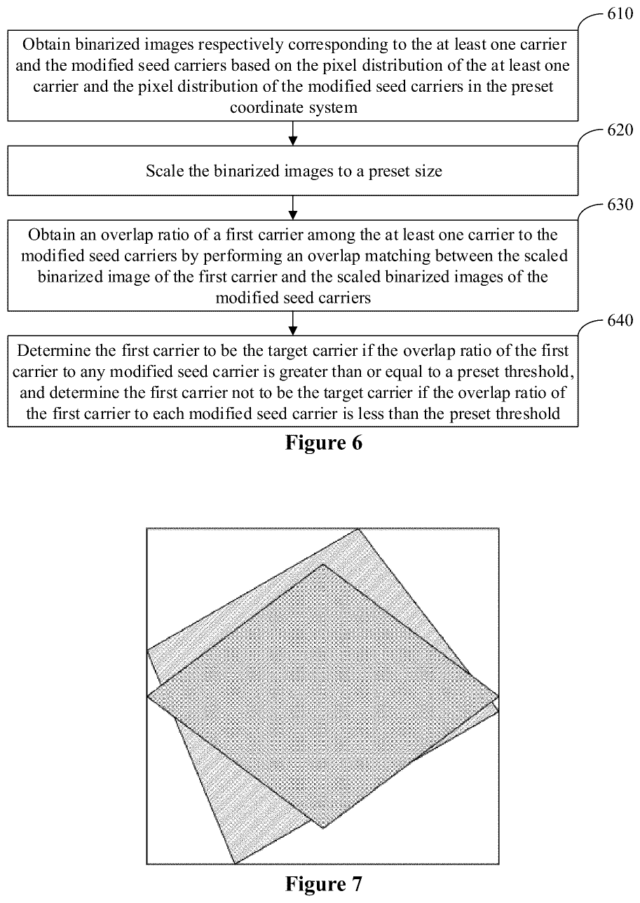

As shown in FIG. 6, the method at least includes the following steps from step 620 to step 640.

In step 610, binarized images respectively corresponding to the at least one carrier and the modified seed carriers are obtained based on the pixel distribution of the at least one carrier and the pixel distribution of the modified seed carriers in the preset coordinate system.

In a specific implementation, the area where the minimum bounding rectangle of the carrier is located, namely, the target detection area of the carrier, may be binarized and used as a binarized image.

In step 620, the binarized images are separately scaled to a preset size.

Since the size of the carriers may be different, in order to determine whether the pixel distribution characteristics of the carriers and the modified seed carriers are the same, it is to scale the binarized images corresponding to the carriers and the modified seed carriers to the same size.

In step 630, an overlap ratio of a first carrier among the at least one carrier to the modified seed carriers is obtained by performing an overlap matching between the scaled binarized image of the first carrier and the scaled binarized images of the modified seed carriers.

The overlapping area between the carrier and the modified seed carriers are the pixel areas where both are black pixels and where both are white pixels. The overlap ratio of the carrier to the modified seed carrier is determined based on the number of pixels in the overlapping area and the total number of pixels in the binarized images of the carrier.

In step 640, the first carrier is determined to be the target carrier if the overlap ratio of the first carrier to any modified seed carrier is greater than or equal to a preset threshold, and the first carrier is determined not to be the target carrier if the overlap ratio of the first carrier to each modified seed carrier is less than a preset threshold.

The preset threshold may be set according to the resolution of the captured image. For example, the preset threshold is set to 80%, the first carrier is determined to be the target carrier if the overlap ratio is greater than or equal to 80%, and the first carrier is determined not to be the target carrier if the overlap ratio is less than 80%.

It should be noted that the first carrier here generally refers to any carrier in the captured image. In specific implementations, it is to overlap and match each carrier in the captured image with the modified seed carriers one by one to determine whether the carrier is the target carrier or not.

As shown in FIG. 7, the trapezoidal carrier is a modified seed carrier, the overlap ratio of the triangular carrier and the modified seed carrier is not high, and the triangular carrier is not the target carrier.

In some embodiments of the present disclosure, based on the above scheme, determining a target carrier in the captured image according to the pixel distribution of at least one carrier in the preset coordinate system includes:
performing a similarity matching between the at least one carrier and the modified seed carriers according to the pixel distribution of the at least one carrier and the pixel distributions of the modified seed carriers in the preset coordinate system to determine a rotation angle of the target carrier relative to the seed carrier.

If the overlap ratio between the carrier and a certain modified seed carrier is greater than the preset threshold, the rotation angle of the carrier relative to the seed carrier is equal to the rotation angle of the modified seed carrier relative to the seed carrier.

In some embodiments of the present disclosure, based on the above scheme, superimposing the target processing pattern on the target carrier in the captured image, based on the position where the target processing pattern on the seed carrier is located in the preset coordinate system includes:
obtaining a translation distance of the target carrier relative to the seed carrier according to the pixel distribution of the target carrier in the preset coordinate system;
superimposing the target processing pattern on the target carrier in the captured image according to the translation distance and rotation angle of the target carrier and the position where the target processing pattern on the seed carrier is located in the preset coordinate system.

In a specific implementation, after the pixel distribution of all carriers in the captured image is known, the center of the carrier can be determined, and the translation distance of the center of the target carrier relative to the center of the seed carrier can be determined. Once knowing the position where the target processing pattern on the seed carrier is located in the preset coordinate system, the center of the target processing pattern can be translated and then rotated to obtain the position of the processing pattern on the target carrier.

In some embodiments of the present disclosure, based on the above scheme, the superimposing the target processing pattern on the target carrier in the captured image according to the translation distance and rotation angle of the target carrier and the position where the target processing pattern on the seed carrier is located in the preset coordinate system includes:
obtaining a center offset between the target processing pattern on the seed carrier and the seed carrier according to the position where the target processing pattern on the seed carrier is located in the preset coordinate system;
obtaining the translation distance of the target processing pattern according to the translation distance, rotation angle and center offset of the target carrier;
translating the target processing pattern to the target carrier in the captured image according to the translation distance of the target processing pattern; and
rotating the target processing pattern on the target carrier in the captured image according to the rotation angle of the target carrier.

It is worth noting that the center of the target processing pattern and the center of the seed carrier may not coincide. If the center of the target processing pattern is directly translated according to the translation distance of the target carrier, the relative position between the target carrier and the target processing pattern corresponding to the target carrier is not equivalent to the relative position between the seed carrier and the target processing pattern corresponding to the seed carrier. Therefore, it is to obtain the center offset between the target processing pattern and the seed carrier first, and then obtain the translation distance of the center of the target processing pattern.

It should be noted that if the size of the target carrier is different from that of the seed carrier, it is to obtain the scaling ratio of the target carrier relative to the seed carrier. Correspondingly, the scaling ratio of the target carrier will affect the translation distance of the center of the target processing pattern on the target carrier. After the translation and rotation of the target processing pattern are completed, a conversion at the corresponding scaling ratio is also required.

In some embodiments of the present disclosure, based on the above solution, the processing control method further includes:
generating GCODE instructions according to the position where the target processing pattern on the seed carrier is located in the preset coordinate system;
processing the target carrier on the processing platform according to the GCODE instructions.

GCODE is an international standard language for the Computerized Numerical Control Industry. In the specific implementation, after the position of the target processing pattern in the preset coordinate system is obtained, the contour vector of the target processing pattern can be determined to determine the GCODE instruction. The carrier on the processing platform is processed, by controlling the movement track of the fixture according to the GCODE instructions, to obtain the finished product.

The embodiments of the processing control apparatus according to the present disclosure are described hereinafter, which can be used to implement the processing control methods in the above-mentioned embodiments of the present disclosure. For the details not disclosed in the embodiments of the processing control apparatus in the present disclosure, reference may be made to the above embodiments of the processing control method in the present disclosure.

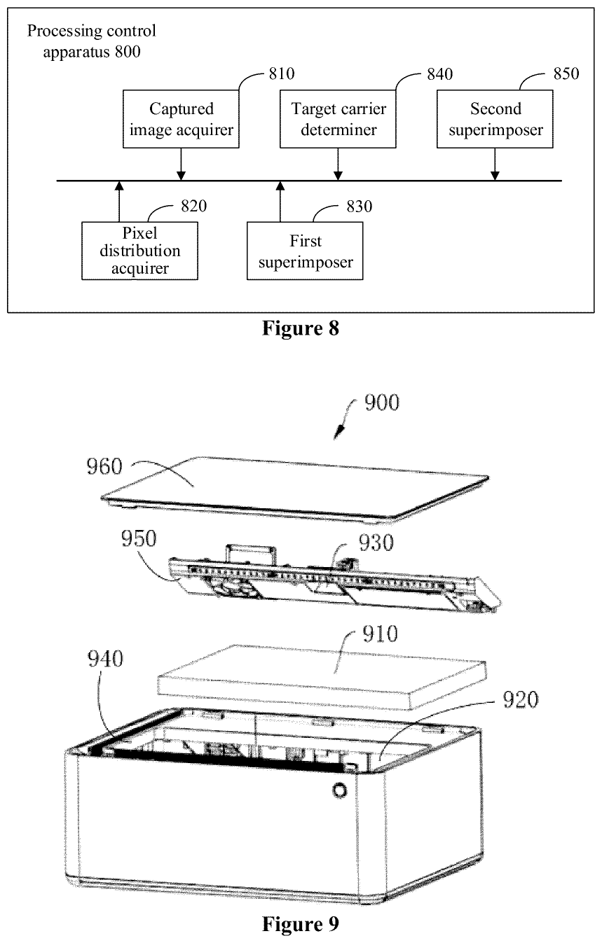

As shown in FIG. 8, the processing control apparatus 800 includes at least:
a captured image acquirer 810, which is configured to acquire a captured image of the processing platform, where at least one carrier is placed on the processing platform;
a pixel distribution acquirer 820, which is configured to acquire a pixel distribution of the at least one carrier in the captured image in the preset coordinate system;
a first superimposer 830, which is configured to determine a carrier among the at least one carrier in the captured image as a seed carrier, to superimpose a target processing pattern on the seed carrier in the captured image, and to determine a position where the target processing pattern on the seed carrier is located in the preset coordinate system;
a target carrier determiner 840, which is configured to determine the target carrier in the captured image according to the pixel distribution of the at least one carrier in the preset coordinate system, where the target carrier is a carrier with the same shape as the seed carrier, among the at least one carrier; and
a second superimposer 850, which is configured to superimpose the target processing pattern on the target carrier in the captured image according to the position where the target processing pattern on the seed carrier is located in the preset coordinate system, such that a relative position between the target carrier and the target processing pattern on the target carrier is equivalent to a relative position between the seed carrier and the target processing pattern on the seed carrier.

A processing device is further provided according to the embodiment of the present disclosure, which includes:
a processing platform for carrying at least one carrier;
a camera for capturing an image of the at least one carrier placed on the processing platform; and
the foregoing processing control apparatus.

The processing device may be any of the following: laser processing device, cutting device, combined laser and cutting device, or printing device. In this embodiment, the combined laser and blade cutting device is used as an example for explanation. As shown in FIG. 9, the processing device is exemplarily a laser and cutting processing device 900. The laser and cutting processing device 900 includes a frame 940 provided with a closed processing space 920. The processing space 920 is configured for accommodating and processing a work piece to be processed (such as a printed matter to be processed). The work piece is an exemplary implementation of a carrier. The frame 940 is provided with a top opening connected with the processing space 920. The frame 940 is also connected with a cover plate 960. The cover plate 960 covers the opening in a rotatable manner. The opening is provided for users to put in a work piece to be processed or take out a processed work piece. The frame 940 is formed by a base plate, side plates, and the like. In the frame 940, there is provided with a track and the processing apparatus arranged on the track. The processing apparatus can move in the X, Y, and Z axis directions in the processing space 920. The processing apparatus includes a laser and a cutting tool, so as to move and carve and cut the work piece with the laser, or cut and scratch the work piece with the cutting tool, which can realize desktop-level and miniaturized settings of the laser and cutting processing device.

A camera 930 is arranged in the laser and cutting processing device, and the processing platform 910 is arranged at the bottom of the processing space 920. The camera 930 faces the processing platform 910 to capture pictures during the processing. For example, the image of the carrier on the processing platform is captured.

The laser and cutting processing device 900 according to the embodiment of the present disclosure includes a mounting bracket 950 arranged in the frame 940. The camera 930 is arranged on the mounting bracket 950 inside the laser and cutting processing device 900. Compared with the configuration of arranging the camera 930 on the cover plate 960, the solution of the embodiment of the present disclosure not only simplifies the wiring of the camera 930, but also can better prevent the deformation of the cover plate 960 or the change of the position of the camera 930 caused by repeated opening and closing, thereby avoiding the debugging before laser processing, improving the processing accuracy and processing efficiency. In addition, compared with the configuration of arranging the camera 930 on the cover plate 960, the configuration of arranging the camera 930 on the mounting bracket 950 can lower the overall height of the entire laser and cutting processing device 900 while ensuring capture the image of the entire work piece to be processed, thereby facilitating users to place the work piece to be processed (when the user places the work piece to be processed, the user's hand will go deep into the processing space 920 or the frame 940; and if the laser and cutting processing device 900 is too high, it is inconvenient for user operation).

The camera 930 is arranged in the middle of the mounting bracket 950. By arranging the camera 930 in the middle of the mounting bracket 950, the image of the entire work piece to be processed can be better captured. The term “middle” in the present disclosure refers to the center position of the component, or a part close to the center position. Optionally, the camera is arranged at the bottom of an accommodating groove. This can better prevent the camera from accidentally injuring when the work piece is processed, and has a better dust-proof effect, improving the service life of the camera. The equivalent circle diameter of the accommodating groove decreases gradually from the arranging surface to the bottom of the accommodating groove, which can better prevent the side wall of the accommodating groove from affecting the shooting effect of the camera.

In the embodiments of the disclosure, the target processing pattern is copied to the target carrier with the same shape as the seed carrier by identifying the shape and pixel distribution of all carriers on the processing platform, so that the carriers with the same shape can be processed in batches by using the target processing pattern, and user experience is improved.

A storage medium is further provided according to an embodiment of the present disclosure, including a program or an instruction. The processing control method or any optional method according to the embodiments of the present disclosure is implemented when the program or instruction is executed.

It should be noted that, those skilled in the art should understand that the embodiments of the present disclosure may be provided as methods, systems, or computer program products. Accordingly, the present disclosure can take the form of an entire hardware embodiment, an entire software embodiment, or an embodiment combining software and hardware aspects. Furthermore, the present disclosure may take the form of a computer program product embodied on one or more computer-usable storage media (including but not limited to disk storage, optical storage, etc.) having computer-usable program code embodied therein.

In the field of processing technology, when processing materials through processing devices, users often need to design drawings in batches and then process based on them. The processing patterns in these drawings are seemingly the same, but some objects are different. In the related art, if users want to design these drawings in batches, they usually use the most primitive method of copying one by one, then manually modifying the text, pictures, or vectors one by one, and then performing the processing, resulting in poor processing efficiency.

Based on this, the embodiment of the present disclosure proposes a processing control method, a processing device, and a computer-readable storage medium. It aims to determine an object to be modified from a plurality of processing objects, realize variable setting, then obtain at least one replacement object corresponding to the object to be modified, and perform replacement in the seed processing pattern to obtain at least one post-replacement image, thereby realizing batch processing of the seed processing pattern, improving the pattern-editing efficiency, and then performing batch processing on a plurality of carriers to be processed by using the batch-processed target processing pattern and the seed processing pattern as the target processing patterns, that is, realizing batch processing of variable objects, making the application scenarios of batch processing wider, and improving the processing efficiency and convenience in item processing.

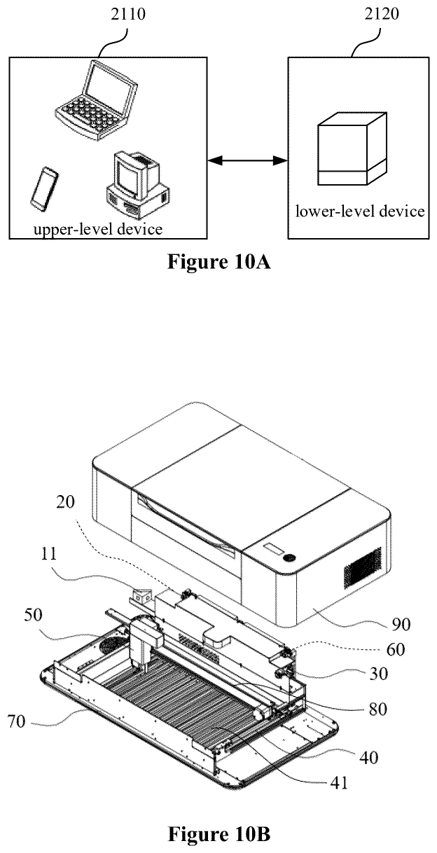

Reference is made to FIG. 10A, which is a schematic diagram of an exemplary implementation environment of the present disclosure. As shown in FIG. 10A, the implementation environment includes an upper-level device 2110 and a lower-level device 2120. A wired or wireless communication connection is established between the upper-level device 2110 and the lower-level device 2120 in advance.

The upper-level device 2110 may be a terminal device installed with XCS, such as a mobile phone, a computer, or a laptop, but is not limited thereto. The upper-level device 2110 may generally refer to one of a plurality of terminals, and this embodiment only takes the upper-level device 2110 as an example for illustration. Those skilled in the art may know that the number of the above-mentioned terminals may be more or less. For example, the above-mentioned terminal may be only one, or there may be a plurality of the above-mentioned terminals. In this case, the implementation environment of the above-mentioned processing control method further includes other terminals. The embodiment of the present disclosure does not limit the number and device types of upper-level devices. A user can import seed processing pattern(s) into the editable interface through the upper-level device 2110, determine object(s) to be modified from a plurality of processing objects to realize variable setting, then obtain at least one replacement object corresponding to the object to be modified, and perform replacement in the seed processing pattern to obtain at least one post-replacement pattern, realizing batch processing of the object to be modified.

The lower-level device 2120 is a processing device, such as a laser engraving machine, a laser cutting machine, a tool cutting machine, a printer, and other devices. The processing device includes a processing head, a communication component, and a controller. The processing head is configured for performing processing on the item (carrier) to be processed. The communication component is configured for receiving processing instructions from the upper-level device 2110. The controller controls the processing head to perform at least one of laser processing, tool cutting processing, and printing processing on the item to be processed based on the processing instructions. The processing head includes a laser head which may have various laser emitting modes. For example, the laser head may be provided with a laser inside to directly emit laser beams for laser processing; or the laser head may be provided with an optical path structure inside, and the processing device is further provided with a laser source. The laser beams emitted by the laser source are transmitted to the laser head through optical elements such as reflectors, and are reflected and output by the laser head to the surface of the processing material.

FIG. 10B schematically shows a structural block diagram of a processing device applying the technical solution of the present disclosure. Here, the processing device is described as having a slide rail as an example. As shown in FIG. 10B, the processing device includes a housing, a processing device bottom plate (i.e., a processing platform) 40, a processing head 50, a laser tube 30, a slide rail 80, a communication component 20, and a controller 60. The processing device bottom plate 40 includes a processing region 41 for placing materials. The housing includes an upper housing 90 and a lower housing 70. The processing head 50 is slidably arranged on the slide rail 80. The communication component 20 is used for receiving processing instructions obtained through the steps of the above-mentioned processing control method. The controller 60 controls the processing head 50 to move on the slide rail 80 to process the item (carrier) to be processed based on the processing instructions. Among them, the communication component 20 and the controller 60 are installed inside the back plate of the laser tube 30, which are not visible from the perspective in FIG. 10B, so they are shown by a dashed block.

In one embodiment, the processing head 50 may include, but is not limited to, a laser head, a cutting head, a plasma cutting head, a water gun head, a drill bit, a pen head, and the like. Correspondingly, the processing performed by the processing device may include, but is not limited to, laser cutting, engraving, drilling, welding, tool cutting, and other processes.

In one embodiment, according to different types of processing devices, the processing device may include a marking processing head, a welding processing head, an engraving processing head, a cutting processing head, etc., which are correspondingly arranged. The processing device may include one or more of these different types of processing heads.

In one embodiment, a reflector 11 is arranged between the processing head 50 and the laser tube 30. The light beam generated by the laser tube 30 is reflected to the processing head 50 after passing through the reflector 11, and then emitted after reflection, focusing, etc., to process the workpiece.

In one embodiment, the processing head 50 may generate a light spot. In another embodiment, the light spot may be generated by other components such as the laser tube 30 of the type of a carbon dioxide laser tube, enter the light beam emitting device through the reflector 11, etc., and finally exit the processing head 50 to process the workpiece. The processing head can emit laser beams, but is not limited to emitting laser beams.

In one embodiment, the upper housing 90 and the lower housing 70 shown in FIG. 10B together enclose an internal space that can accommodate the processing material. The upper housing 90 and the lower housing 70 may be detachably connected or fixedly connected, or the upper housing 90 and the lower housing 70 may be an integrally formed structure. In one embodiment, the upper housing 90 is further provided with a rotatable cover plate. The operator can open the internal space by opening or closing the cover plate to put in or take out the processing material. Through the blocking and/or filtering effect of the upper housing 90 and the lower housing 70, it is possible to prevent laser overflow from causing personal injury to the operator when the processing head 50 emits laser during operation.

As shown in the example of FIG. 10B, the slide rail 80 is arranged in the above-mentioned internal space, and the processing head 50 is installed on the slide rail 80. The slide rail 80 may be an X, Y-axis guide rail. The X, Y-axis guide rail may adopt a linear guide rail, or a guide rail with a smooth shaft and a roller for sliding, etc., as long as it can drive the processing head 50 to move and process in the X, Y-axis directions. The processing head 50 may further be provided with a Z-axis moving track inside for moving and focusing in the Z-axis direction before and/or during processing.

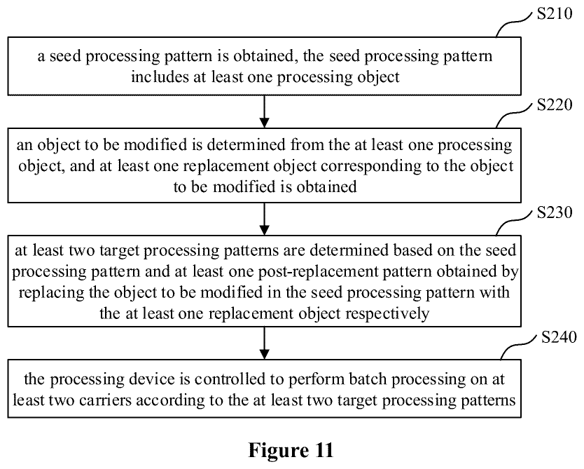

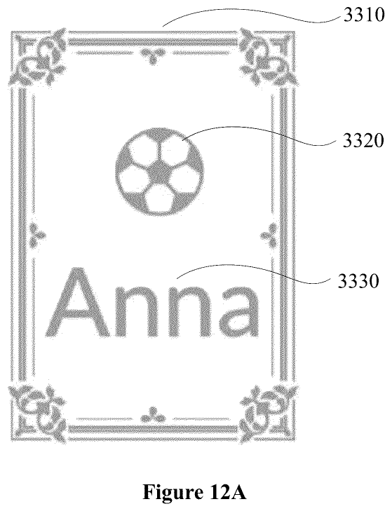

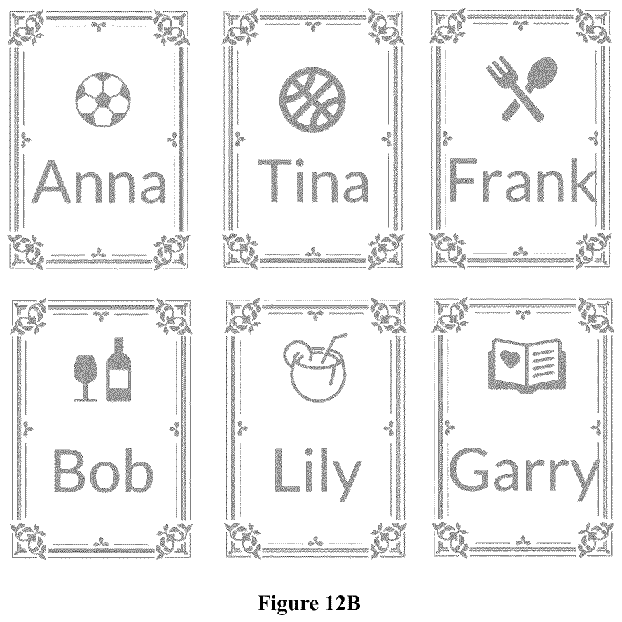

Reference is made to FIG. 11, which is a flowchart of a processing control method according to an exemplary embodiment of the present disclosure. The method may be applied to an upper-level device. The upper-level device is a terminal device, which includes but is not limited to a computer, a tablet computer, or a mobile phone.

The processing control method proposed by the embodiment of the present disclosure will be described in detail below with a computer serving as a specific executor.

As shown in FIG. 11, in an exemplary embodiment, the processing control method at least includes steps S210 to S240, which are described in detail as follows.

In Step S210, a seed processing pattern is obtained. The seed processing pattern includes at least one processing object.

In Step S220, an object to be modified is determined from the at least one processing object, and at least one replacement object corresponding to the object to be modified is obtained.

In the embodiment of the present disclosure, the seed processing pattern is a pattern composed of all processing objects in a current editable interface. The seed processing pattern may include one processing object or a plurality of processing objects.

The case of the seed processing pattern including a plurality of processing objects is taken as an example, as shown in FIGS. 12A and 12B. FIG. 12A is a schematic diagram of a seed processing pattern according to an exemplary embodiment of the present disclosure, and FIG. 12B is a schematic diagram of a target processing pattern according to an exemplary embodiment of the present disclosure. In the seed processing pattern in FIG. 12A, the processing objects include a vector graphic 3310, a vector graphic 3320, and text 3330; among them, the vector graphic 3310 is a “border graphic”, the vector graphic 3320 is a “football graphic”, and the text 3330 is “Anna”. In FIG. 12B, by setting the vector graphic 3310, the vector graphic 3320, and the text 3330 in the seed processing pattern as objects to be modified, at least two replacement objects corresponding to the vector graphic 3320 are obtained, including a “basketball graphic”, a “knife and fork graphic”, a “wine glass graphic”, a “beverage graphic”, and a “book graphic”; and at least two replacement objects corresponding to the text 3330 are obtained, including “Tina”, “Frank”, “Bob”, “Lily”, and “Garry”. Then, the vector graphic 3320 and the text 3330 are respectively replaced in the seed processing pattern, and the vector graphic 3310 remains unchanged, thereby obtaining the corresponding target processing pattern.

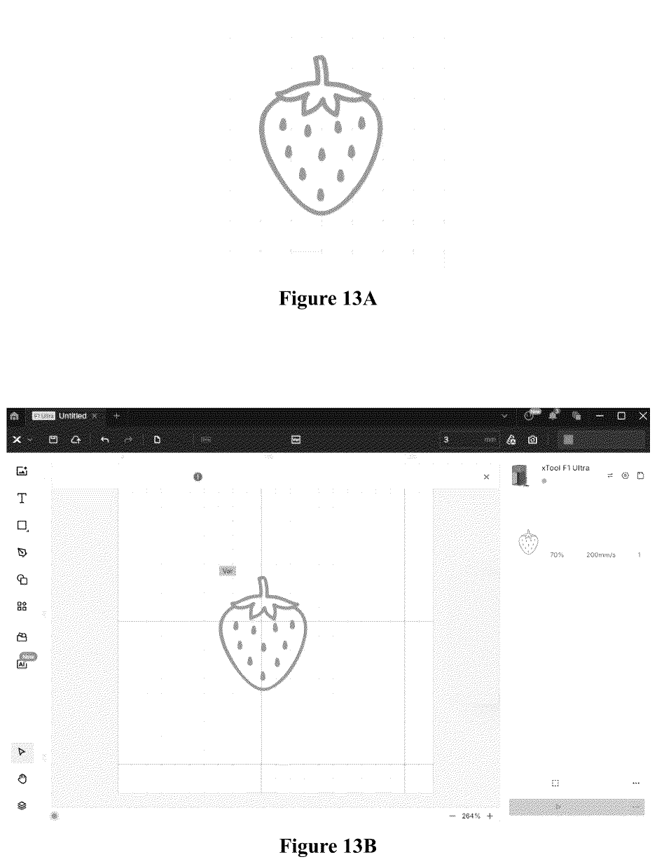

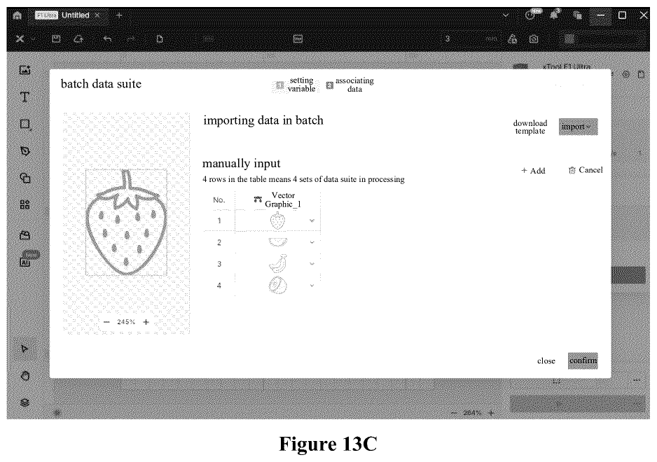

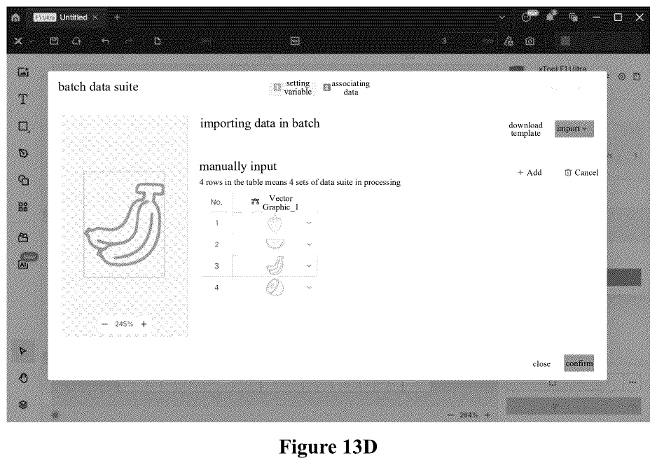

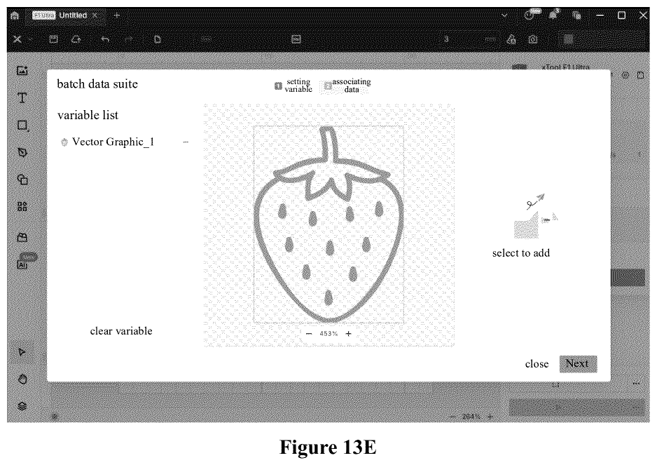

The case of the seed processing pattern including one processing object is taken as an example, as shown in FIG. 13A. FIG. 13A is a schematic diagram of a seed processing pattern according to an exemplary embodiment of the present disclosure, where the seed processing pattern only includes one processing object, i.e., a strawberry-shaped vector graphic.

In some embodiments, the seed processing pattern is displayed in the editable interface; determining the object to be modified from the at least one processing object includes: when there is one processing object, in response to a variable setting operation for the processing object, determining the processing object set as a variable as the object to be modified; and/or, when there are a plurality of processing objects, in response to a variable setting operation for the plurality of processing objects, determining the processing object(s) set as variable(s) as the object(s) to be modified.

It can be understood that when the seed processing pattern only includes one processing object, during variable setting, the single processing object is set as a variable, that is, the object to be modified.

When the seed processing pattern includes a plurality of processing objects, according to different user requirements, all processing objects in the seed processing pattern may be subjected to variable setting operations, and all processing objects may be determined as objects to be modified; or one or several of all the processing objects may be subjected to variable setting operations, and the one or several processing objects may be determined as object(s) to be modified.

In some embodiments, after determining the object to be modified, the user may replace the object to be modified or keep it unchanged.

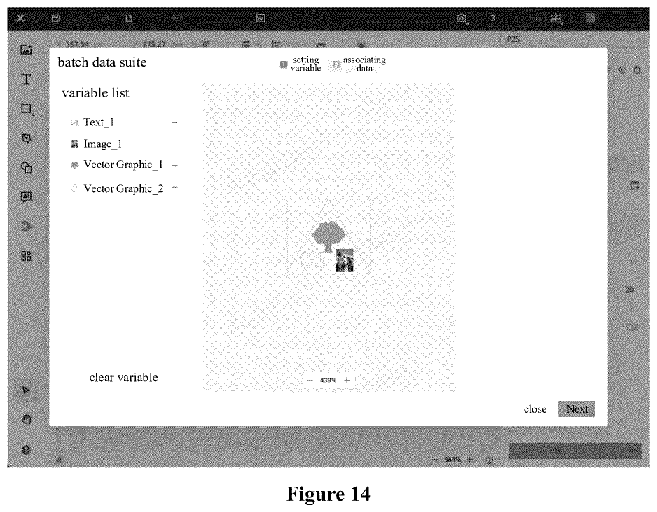

With reference to FIG. 14, FIG. 14 is an application schematic diagram of determining an object to be modified in a seed processing pattern according to an exemplary embodiment of the present disclosure. In FIG. 14, the seed processing pattern on the editable interface includes four processing objects, including text, a lady's image, a tree-shaped image, and a triangle. The identification information corresponding to the text is Text_1, the identification information corresponding to the lady's image is Image_1, the identification information corresponding to the tree-shaped image is Vector Graphic_1, and the identification information of the triangular object is Vector Graphic_2. When a variable setting operation for the processing object by the user is detected, the processing object set as a variable is determined as the object to be modified, and the identification information of the processing object set as a variable is added to the variable list column.

In some embodiments, after determining the object to be modified from the at least one processing object, the method further includes:
displaying the at least one processing object in the editable interface, and performing differentiated display for the determined object to be modified;
where the differentiated display includes at least one of adding a set identifier at a set position of the object to be modified, performing color differentiated display for the object to be modified, performing line differentiated display for the object to be modified, and performing brightness differentiated display for the object to be modified.

In an embodiment, after determining the object to be modified from the seed processing pattern, only the determined object to be modified is displayed in a differentiated manner, such as adding a set identifier at a set position (such as the upper left corner, upper right corner, etc.) of the object to be modified, or displaying the object to be modified in a color different from other processing objects, or displaying the object to be modified in a line-type different from other processing objects, or displaying the object to be modified in a brightness different from other processing objects. For example, the seed processing pattern is as shown in FIG. 12A, including a border graphic, a football graphic, and the text Anna. Assuming the football graphic is determined as the object to be modified, at this time, in the editable interface, the football graphic may be displayed in red, while the border graphic and the text Anna may be displayed in green.

It can be understood that when the seed processing pattern only includes one processing object and the processing object is determined as the object to be modified, a set identifier may be added at a set position of the single processing object for differentiated display, or the processing object set as the object to be modified may be displayed in a differentiated manner with a color/line-type/brightness different from the initial processing object. As shown in FIG. 13B, FIG. 13B is a schematic diagram of an object to be modified according to an exemplary embodiment of the present disclosure. It can be seen that the seed processing pattern only includes one processing object and after the processing object is determined as the object to be modified, a text identifier “var” is added at the upper left corner of the object to be modified in the editable interface, so as to be different from the seed processing pattern in FIG. 13A.

In this way, by performing differentiated display for the object to be modified, the object to be modified can be presented more clearly, facilitating the user's subsequent operations.

In some embodiments, obtaining at least one replacement object corresponding to the object to be modified includes: in response to a confirmation operation for a candidate object, associating the candidate object with the object to be modified to establish an association relationship between the candidate object and the object to be modified; determining the candidate object having the association relationship with the object to be modified as the replacement object corresponding to the object to be modified.

In some embodiments, before associating the candidate object with the object to be modified in response to the confirmation operation for the candidate object to establish an association relationship between the candidate object and the object to be modified, the method further includes: in response to an import operation for a candidate object document, storing the candidate object document in a specified storage area and displaying the candidate object document in the editable interface; wherein the candidate object document includes a plurality of candidate objects.

In the embodiment of the present disclosure, the candidate object document is a document pre-edited for the object to be modified in the seed processing pattern. The candidate object document includes a plurality of replacement objects corresponding to respective objects to be modified, arranged in a preset order. Once identifying the import operation for the candidate object document, the upper-level device first imports the candidate object document into a specified storage area of the upper-level device, displays the plurality of candidate objects in the candidate object document in the editable interface, and the user can edit the candidate objects in the editable interface; the user performs a confirmation operation by clicking a preset confirmation button. After identifying the confirmation operation, the upper-level device performs batch superimposition according to the arrangement order in the candidate object document. In some embodiments, the specified storage area is a preset database in XCS. In the embodiment of the present disclosure, candidate objects can be imported manually or automatically, so that batch generation of differentiated and personalized data suite can be realized.

In some embodiments, the candidate object document may be in different compression formats, such as zip format, rar format, or 7z format.

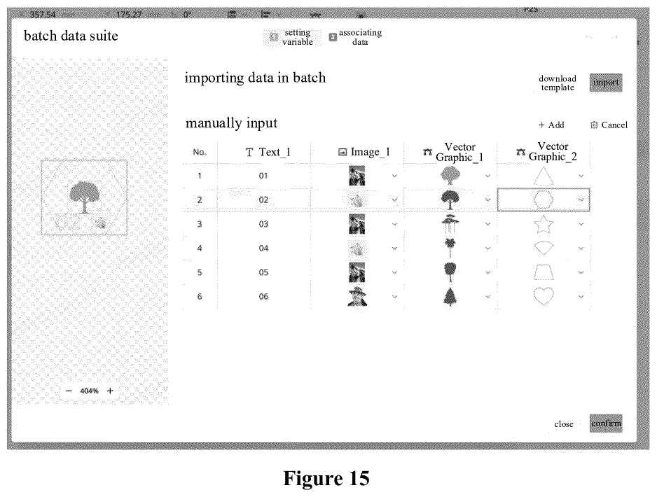

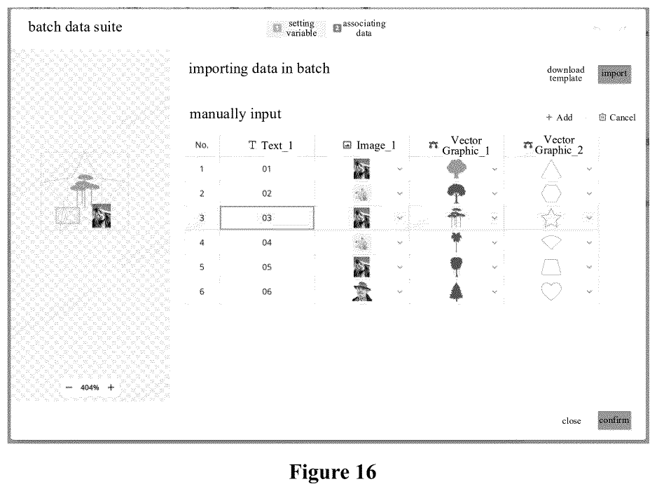

Referring to FIGS. 15 and 16, FIG. 15 is an application schematic diagram of importing a candidate object document according to an exemplary embodiment of the present disclosure; FIG. 16 is an application schematic diagram of importing a candidate object document according to another exemplary embodiment of the present disclosure. The candidate object document includes a plurality of candidate objects with different identification information. The row information in the candidate object document is used to characterize the identification information of the candidate objects, for example: the identification information includes “Text_1”, “Image_1”, “Vector Graphic_1”, and “Vector Graphic_2”; the column information in the candidate object document is used to characterize a plurality of candidate objects with the same identification information, for example: the candidate objects with the identification information “Text_1” include 01, 02, 03, 04, 05, and 06; the candidate objects with the identification information “Image_1” include a lady's image, a man's image, and a cartoon image; the candidate objects with the identification information “Vector Graphic_1” include six different tree-shaped images; the candidate objects with the identification information “Vector Graphic_2” include six different polygonal images. In this way, when determining the object to be modified, search and matching can be performed according to the corresponding identification information, so as to obtain the object matching the processing object and improve the modification accuracy.

For example, the plurality of candidate objects in the candidate object document in FIG. 15 are used to replace the objects to be modified after variable setting in FIG. 14. The identification information of the objects to be modified in FIG. 14 corresponds to the identification information in FIG. 15, and the replacement objects corresponding to respective objects to be modified in the same row in FIG. 15 form a data suite, which is used to replace the objects to be modified in FIG. 14. For example: when replacing the objects to be modified in FIG. 14 with the data suite in the second row in FIG. 15, the data suite in the second row in FIG. 15 includes the candidate object 02 with the identification information “Text_1”, the candidate object cartoon image with the identification information “Image_1”, the candidate object tree-shaped image with the identification information “Vector Graphic_1”, and the candidate object regular hexagon with the identification information “Vector Graphic_2”; the objects to be modified in the seed processing pattern as shown in FIG. 14 are replaced according to the corresponding identification information, for example: the object to be modified with the identification information “Text_1” in FIG. 14 is 01, and becomes 02 after replacement; the object to be modified with the identification information “Image_1” in FIG. 14 is a lady's image, and becomes a cartoon image after replacement; the object to be modified with the identification information “Vector Graphic_1” in FIG. 14 is the first tree-shaped image, and becomes the second tree-shaped image after replacement; the candidate object with the identification information “Vector Graphic_2” in FIG. 14 is a regular triangle, and becomes a regular hexagon after replacement.

For example, the plurality of candidate objects in the candidate object document in FIG. 16 are used to replace the objects to be modified which were subjected to variable setting in FIG. 14. The identification information of the objects to be modified in FIG. 14 corresponds to the identification information in FIG. 16. For example: when replacing the objects to be modified in FIG. 14 with the data suite in the third row in FIG. 16, the data suite in the third row in FIG. 16 includes the candidate object 03 with the identification information “Text_1”, the candidate object lady's image with the identification information “Image_1”, the candidate object tree-shaped image with the identification information “Vector Graphic_1”, and the candidate object regular pentagram with the identification information “Vector Graphic_2”; the objects to be modified of the seed processing pattern in FIG. 14 is replaced according to the corresponding identification information, for example: the object to be modified with the identification information “Text_1” in FIG. 14 is 01, and becomes 03 after replacement; the object to be modified with the identification information “Image_1” in FIG. 14 is a lady's image, and since the replacement object with the identification information “Image_1” in the data suite in the third row in FIG. 16 is also the same lady's image, it is also the same lady's image after replacement; the object to be modified with the identification information “Vector Graphic_1” in FIG. 14 is the first tree-shaped image, and becomes the third tree-shaped image after replacement; the candidate object with the identification information “Vector Graphic_2” in FIG. 14 is a regular triangle, and becomes a regular pentagram after replacement.

In some embodiments, before associating the candidate object with the object to be modified in response to the confirmation operation for the candidate object to establish an association relationship between the candidate object and the object to be modified, the method further includes: obtaining a preset document, where the preset document is displayed in the editable interface and includes at least one candidate object; in response to an editing operation for the preset document, obtaining an edited preset document; in response to an import operation for the edited preset document, storing the edited preset document in a specified area and displaying the edited preset document in the editable interface.

It should be understood that if a candidate object document has been imported into the editable interface, when a new document needs to be imported to replace the object to be modified in the same seed processing pattern, directly importing the new document will cause the existing candidate object document to be overwritten. In the embodiment of the present disclosure, the already imported candidate object document, i.e., the preset document, is obtained, so that the user can edit the preset document as a template to add new replacement objects required by the user, and the typesetting format after editing is the same as that of the preset document, facilitating the replacement of the object to be modified in the target processing pattern.

For example, if the user wants to add a new replacement object for the object to be modified in the target processing pattern of FIG. 14, the already imported candidate object document, i.e., the preset document, may be obtained first. The preset document displays six sets of data suite the same as those in FIGS. 15 and 16. If the new replacement objects to be added by the user include three sets of data suite, the new replacement objects may be directly added at the positions of the 7th, 8th, and 9th rows in the preset document, thereby obtaining three new sets of data suite. After editing the preset document, the edited preset document is obtained, and then the edited preset document is imported into the editable interface of the upper-level device. At this time, on the basis of the original six sets of data suite, the newly added three sets of data suite are updated into the editable interface, so that the original six sets of data suite will not be overwritten.

In some embodiments, before obtaining at least one replacement object corresponding to the object to be modified, the method further includes: in response to a trigger operation for a candidate object, adding the candidate object to the editable interface; or deleting the candidate object.

It can be understood that an add button and a delete button are provided in the editable interface, according to the embodiment of the present disclosure. The user can manually add the corresponding replacement object directly in the editable interface by clicking the add button, or delete the corresponding replacement object directly in the editable interface. This enables the user to timely add desirable replacement object, thereby improving the flexibility of batch modification.

In some embodiments, after obtaining at least one replacement object corresponding to the object to be modified, the method further includes:
in response to a variable setting operation for the object to be modified, displaying the object to be modified in a first region of the editable interface, and displaying the object to be modified and at least one replacement object associated with the object to be modified in a second region of the editable interface.

In an embodiment, as shown in FIG. 13C, FIG. 13C is a schematic diagram of a replacement object according to an exemplary embodiment of the present disclosure. It can be seen that after the replacement object is determined, the initial object to be modified is displayed on the left page of the editable interface, and the determined replacement objects are presented in the form of a list on the right page of the editable interface. Of course, the list also includes the initial object to be modified. For example, if the object to be modified is a strawberry, the strawberry is displayed in the first region on the left and at the top of the list in the second region on the right.

Through this partitioned presentation, the replacement object and the object to be modified can be clearly distinguished.

In some embodiments, the method further includes: in response to a selection operation for one of the at least one replacement object, switching to display the selected replacement object in the first region.

In an embodiment, as shown in FIG. 13D, FIG. 13D is a schematic diagram of a replacement object according to an exemplary embodiment of the present disclosure. It can be seen that in response to a selection operation for the replacement object banana, the display on the left side of the editable interface is switched from strawberry to banana. Since the display size of the object in the first region on the left is larger than that of the object in the second region on the right, it is more convenient for the user to view or preview the replacement object in detail.

In some embodiments, determining the object to be modified from the at least one processing object and obtaining at least one replacement object corresponding to the object to be modified includes:
in response to a trigger operation for a variable setting control in the editable interface, displaying a pop-up window in the editable interface, the pop-up window including a variable setting page;
in the variable setting page, in response to a variable setting operation for the at least one processing object, determining the processing object set as a variable as the object to be modified;
the pop-up window including a data associating control, and in response to a trigger operation for the data associating control, switching the pop-up window from the variable setting page to a data associating page;
in the data associating page, in response to a candidate object adding operation and/or import operation for the object to be modified, displaying an added and/or imported candidate object in the data associating page; and
in response to a trigger operation on a confirmation control for the candidate object, determining the candidate object as the replacement object corresponding to the object to be modified.

In an embodiment, the editable interface includes a variable setting control. As shown in FIG. 13B, there is a “var” control next to the “Variable Object-Batch Processing” control at the top of the page, which is the variable setting control. When the seed processing pattern is displayed in the editable interface, in response to a trigger operation (such as a click operation) for the “var” control, a pop-up window is displayed in the editable interface, as shown in FIG. 13E. FIG. 13E is a schematic diagram of a pop-up page according to an exemplary embodiment of the present disclosure. The pop-up window includes the variable setting control corresponding to the variable setting page and a data associating control corresponding to the data associating page. After the pop-up window is displayed, the variable setting page is displayed by default. On this page, variable setting can be performed for the processing objects included in the seed processing pattern, that is, as mentioned above, the single processing object included in the seed processing pattern can be set as a variable, and when the seed processing pattern includes a plurality of processing objects, one or more or all of them can be set as variables, and the processing object(s) set as variable(s) is(are) the object(s) to be modified.

After completing the setting of the object to be modified, in response to a trigger operation for the data associating control, the pop-up window is switched from the variable setting page to the data associating page as shown in FIG. 13D. The data associating page includes a candidate object import control, a candidate object input control, and a candidate object delete control. In the data associating page, in response to a candidate object adding operation and/or import operation for the object to be modified, the added and/or imported candidate object is displayed in the data associating page. The specific adding/importing process is detailed above and will not be repeated here.

The data associating page further includes a confirmation control. In response to a trigger operation on the confirmation control for the candidate object, the candidate object is determined as the replacement object corresponding to the object to be modified.

Through the above interaction process, it is convenient for the user to set the object to be modified and the replacement object simply and quickly, simplifying the operation process.

In Step S230, at least two target processing patterns are determined based on the seed processing pattern and at least one post-replacement pattern obtained by replacing the object to be modified in the seed processing pattern with the at least one replacement object respectively.

In the embodiment of the present disclosure, if there is only one object to be modified in the seed processing pattern, each replacement object represents the post-replacement pattern. In this way, a plurality of target processing patterns are obtained based on the seed processing pattern and the replacement objects.

If there are a plurality of objects to be modified in the seed processing pattern, when replacing the plurality of objects to be modified, the replacement objects corresponding to respective objects to be modified may be combined to obtain sets of data suite, such as the data suite shown in each row of FIGS. 15 and 16, and then the objects to be modified are replaced with the replacement objects in the data suite of each row to obtain the corresponding target processing pattern. Through the replacement objects in the six rows of data suite shown in FIGS. 15 and 16, six target processing patterns can be obtained.

Exemplarily, in an embodiment of the present disclosure, when there is one post-replacement pattern, the seed processing pattern and the at least one post-replacement pattern are determined as the target processing patterns, so as to facilitate controlling the processing device to perform batch processing on a plurality of carriers.

Exemplarily, in an embodiment of the present disclosure, when there are a plurality of post-replacement patterns, the seed processing pattern and the plurality of post-replacement patterns may be determined as the target processing patterns, or only the plurality of post-replacement patterns may be determined as the target processing patterns, so that batch processing on a plurality of carriers can be realized.

In Step S240, the processing device is controlled to perform batch processing on at least two carriers according to the at least two target processing patterns.

In the technical solution provided by the embodiment of the present disclosure, by determining the object to be modified from a plurality of processing objects, variable setting is realized, then at least one replacement object corresponding to the object to be modified is obtained, and replacement is performed in the seed processing pattern to obtain at least one post-replacement pattern, thereby realizing batch processing of the seed processing pattern, improving the pattern-editing efficiency, and then performing batch processing on a plurality of carriers by determining the post-replacement pattern after batch processing and the seed processing pattern as the target processing patterns, that is, realizing batch processing of variable objects, making the application scenarios of batch processing wider, and improving the processing efficiency and convenience of carriers to be processed.

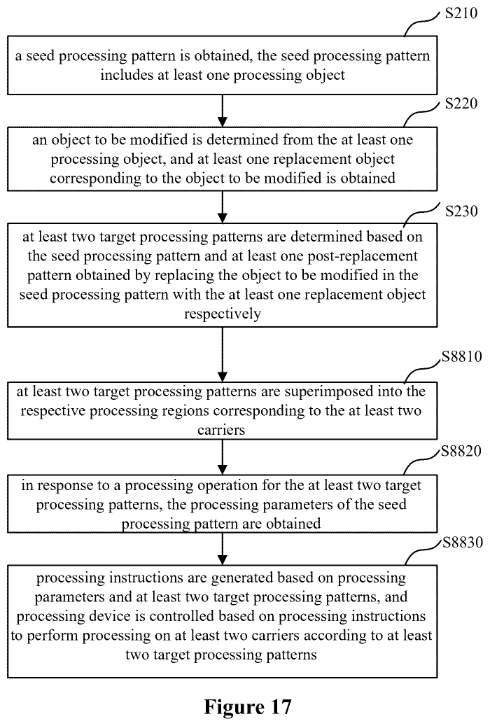

Reference is made to FIG. 17, which is a flowchart of a method for controlling a processing device to perform batch processing on at least two carriers according to at least two target processing patterns in step S240 in the embodiment shown in FIG. 11. The method at least includes steps S8810 to S8830, which are described in detail as follows.

In Step S8810, the at least two target processing patterns are superimposed into the respective processing regions corresponding to the at least two carriers.

In the embodiment of the present disclosure, at least two carriers are placed in the processing regions of the processing device.

In some embodiments, the at least two target processing patterns may be superimposed into the respective processing regions corresponding to the at least two carriers through the following process:
obtaining a first image captured for the at least two carriers, determining at least two target carriers based on the first image, and superimposing the at least two target processing patterns into the processing regions corresponding to respective target carriers.

In an embodiment, first, image capturing is performed for the at least two carriers placed in the processing region to obtain a first image. The image capturing here may be performed by a device external to the processing device, such as a mobile phone or a camera, or by an image capturing device provided inside the processing device. The image capturing device here includes but is not limited to a camera or a scanner.

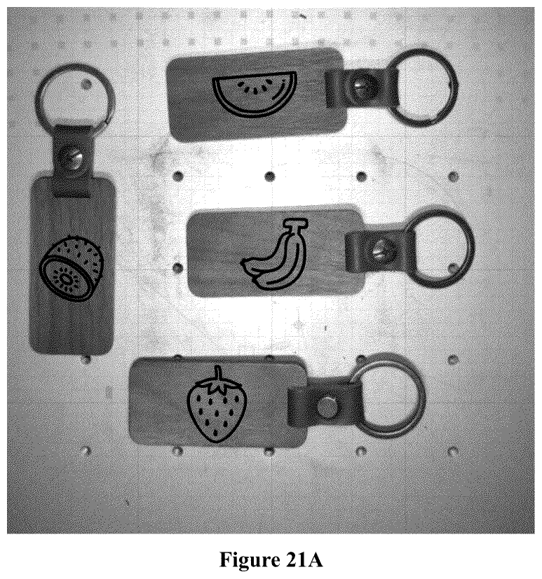

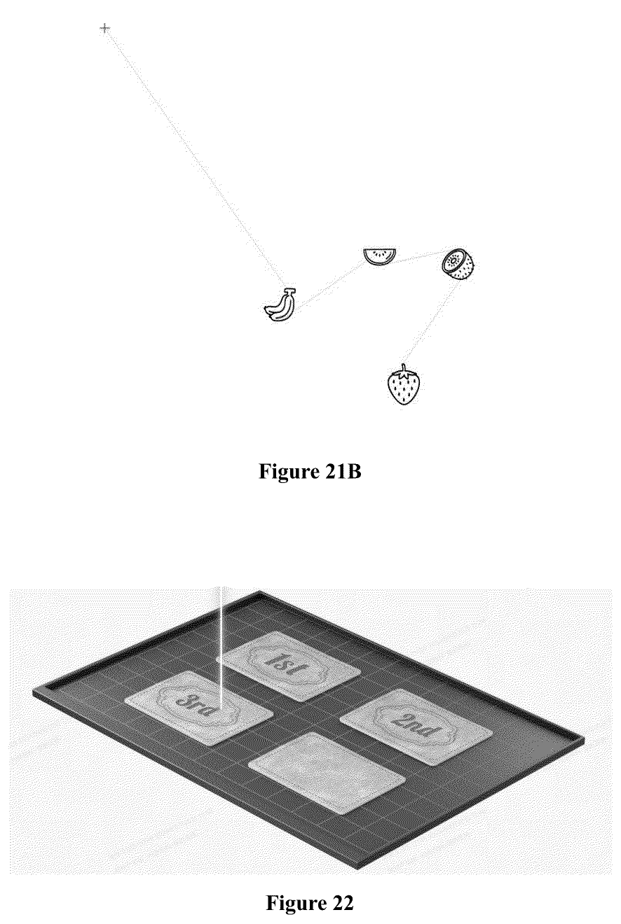

After obtaining the first image, since the first image includes at least two carriers, at least two target carriers are determined based on the first image, and then the at least two target processing patterns are superimposed into the processing regions corresponding to respective target carriers. As shown in FIG. 21A, FIG. 21A is another application schematic diagram of superimposing target processing patterns in a close-up image according to an exemplary embodiment of the present disclosure. Four target carriers are determined based on the first image, and then the four target processing patterns shown in FIG. 13C are respectively superimposed onto the corresponding target carriers.

In some embodiments, the above-mentioned first image is a close-up image obtained by close-up image capturing; at least two target carriers are determined based on the first image; the at least two target processing patterns are superimposed into the processing regions corresponding to respective target carriers; these steps may be implemented in the following manner.

In Step S8811, all carriers to be processed included in the close-up image are determined as target carriers, and the close-up image is displayed in the editable interface.

In Step S8812, the at least two target processing patterns are superimposed into the respective processing regions corresponding to respective target carriers in the close-up image.

As an example, close-up image capturing may be performed by a close-up camera provided in the processing device. In the close-up image obtained by close-up image capturing for at least one carrier, the proportion of the carrier in the image is larger, and the proportion of the processing region as the background in the image is smaller. In this way, a clearer carrier can be obtained, facilitating subsequent image superimposition. After obtaining the close-up image, the image is displayed in the editable interface, so that the user can clearly see the number and positional relationship of the carriers, and also subsequent image superimposition is more intuitive.

It can be understood that in the embodiment of the present disclosure, all carriers in the processing region of the processing device are regarded as target carriers for processing. Therefore, all carriers included in the close-up image can be determined as target carriers. Here, the close-up image may default to include all carriers placed in the processing regions. Then, the target processing patterns are superimposed into the processing regions of the target carriers in the close-up image.

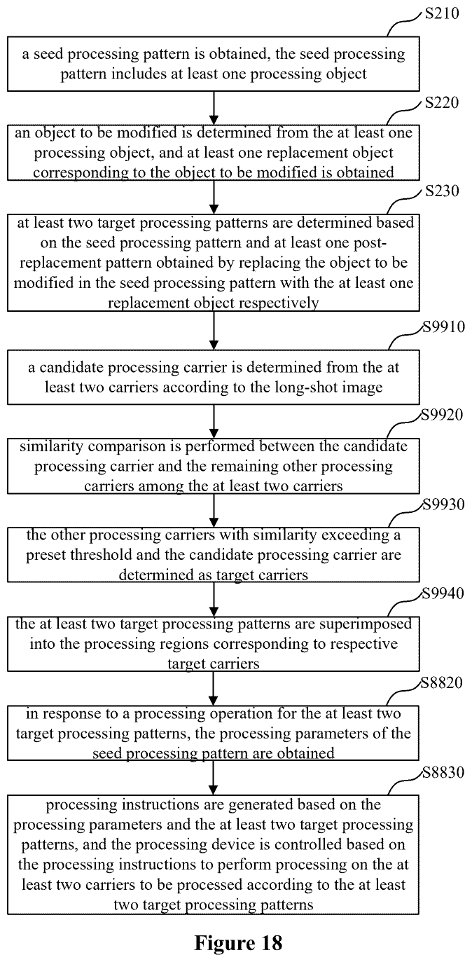

In another exemplary embodiment, the above-mentioned first image is a long-shot image obtained by long-shot image capturing; and in this case the determining at least two target carriers based on the first image and superimposing the at least two target processing patterns into the processing regions corresponding to respective target carriers may be implemented through the process shown in FIG. 18. Reference is made to FIG. 18, which is a flowchart of a method for superimposing a target processing pattern according to another exemplary embodiment of the present disclosure. The method at least includes steps S910 to S950, which are described in detail as follows.

As an example, long-shot image capturing may be performed by a long-shot camera provided in the processing device. In the long-shot image obtained by long-shot image capturing for at least one item (carrier) to be processed, the proportion of the carrier to be processed in the image is smaller than that in the close-up image, and the proportion of the processing region as the background in the image is larger than that in the close-up image. The depth of field of the close-up image is a first depth of field, and the depth of field of the long-shot image is a second depth of field, and the first depth of field is smaller than the second depth of field.

In Step S9910, a candidate processing carrier is determined from the at least two carriers according to the long-shot image.

In some embodiments, the at least two target processing patterns may be respectively superimposed into the processing regions corresponding to the at least two carriers through the following process.

In Step S9921: carriers are identified from the long-shot image to obtain identification frames.

In Step S9922, in response to a trigger operation for one of the identification frames, the carrier corresponding to the identification frame is determined as the candidate processing carrier.

In the embodiment of the present disclosure, if the trigger operation is a confirmation operation for the identification frame, the carrier corresponding to the confirmed identification frame is determined as the candidate processing carrier; if the trigger operation is an editing operation for the identification frame, the carrier corresponding to the edited identification frame is determined as the candidate processing carrier.

For example, since different types of carriers may be placed in the processing regions of the processing device, such as circular carriers and rectangular carriers, any carrier may be randomly identified in the long-shot image through a preset identification algorithm to obtain the identification frame of the carrier. And then the user's trigger operation for the identification frame is judged. If the carrier is not the type of carrier that the user actually wants to process, the user will edit the identification frame, such as dragging the identification frame to a desirable carrier that the user actually wants to process and framing the desirable carrier. After the user completes the editing, the carrier corresponding to the edited identification frame is determined as the candidate processing carrier. In this way, when there are multiple carriers of different types, the carrier that the user actually wants to process can be accurately determined, thereby improving the accuracy of target processing pattern superimposition and further improving processing accuracy. If the user directly clicks the confirmation button after obtaining the identification frame for the carrier, it is considered that the randomly identified carrier is the carrier that the user actually wants to process. In this way, by identifying the carrier to be processed in the long-shot image to obtain the identification frame, the carrier that the user actually wants to process can be determined among a plurality of carriers, and processing accuracy can be improved.

In another embodiment, the candidate processing carrier may also be determined in the following manner, including: obtaining a long-shot image obtained by shooting a plurality of carriers to be processed; performing carrier identification on the long-shot image to obtain an identification frame; comparing the image of the carrier corresponding to the identification frame with a preset image; if matched, determining the carrier corresponding to the identification frame as the candidate processing carrier; if not matched, re-performing carrier identification on the long-shot image to obtain another identification frame until a carrier the same as the preset image is determined. This can realize automatic confirmation of the candidate processing carrier without the user manually confirming or editing the identification frame, thereby improving user experience.

In Step S9920, similarity comparison is performed between the candidate processing carrier and the remaining other processing carriers among the at least two carriers.

In Step S9930, the other processing carriers with similarity exceeding a preset threshold and the candidate processing carrier are determined as target carriers. The range of the preset threshold is 95%-100%.

It can be understood that by finding out other processing carriers with similarity exceeding the preset threshold, all target carriers that the user actually wants to process can be determined from the processing regions of the processing device, thereby facilitating more accurate batch superimposition of target processing patterns.

In Step S9940, the at least two target processing patterns are superimposed into the processing regions corresponding to respective target carriers.

In some embodiments, the at least two target processing patterns may be superimposed into the processing regions corresponding to respective target carriers through the following process.

In Step S9951, a close-up image captured by close-up image capturing for the target carrier is obtained, and the close-up image is displayed in the editable interface; the processing region included in the close-up image is smaller than the processing region included in the long-shot image;

In Step S9952, the at least two target processing patterns are superimposed into the processing regions corresponding to respective target carriers in the close-up image.

It can be understood that since the long-shot image includes many elements and is not clear enough, superimposing the target processing pattern may easily lead to superimposition deviation, resulting in inaccurate processing. Therefore, after determining all target carriers that the user actually wants to process in the processing region of the processing device, close-up image capturing is performed on the target carriers to obtain a clearer image displayed in the editable interface, thereby facilitating more accurate superimposition of the target processing pattern into the processing region corresponding to the target carrier. It should be noted that when performing image capturing for the processing region of the processing device, the long-shot image may capture a relatively large processing region, while the close-up image captures a relatively small processing region.

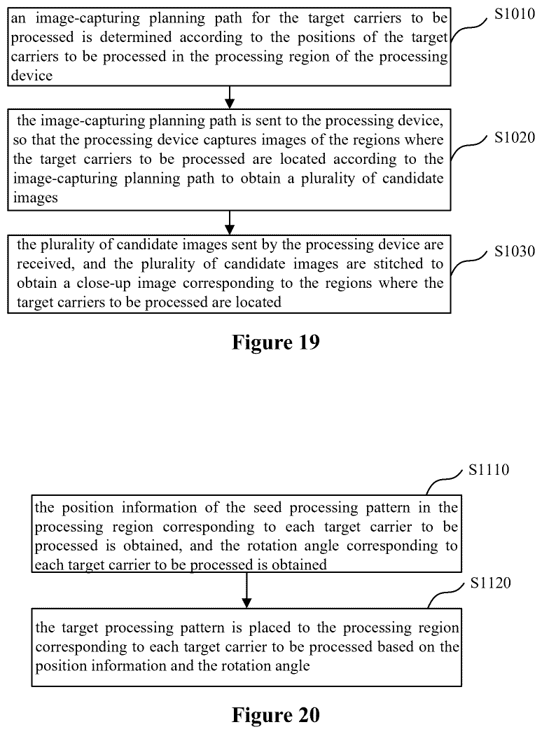

Reference is made to FIG. 19, which is a flowchart of a method for obtaining a close-up image captured by close-up shooting on a target carrier to be processed according to an exemplary embodiment of the present disclosure. The method at least includes steps S1010 to S1030, which are described in detail as follows.

In Step S1010, an image-capturing planning path for the target carriers to be processed is determined according to the positions of the target carriers to be processed in the processing region of the processing device.

In the embodiment of the present disclosure, after obtaining the positions of the target carriers to be processed in the processing region of the processing device, a reasonable image-capturing planning path can be obtained by calculating each position through a preset path planning algorithm.

For example, the position of the target carrier to be processed in the processing region of the processing device may be the position coordinates of the geometric center point of the target carrier to be processed. By connecting the position coordinates of the geometric center points of the target carriers to be processed, the image-capturing planning path of the target carriers to be processed can be obtained.

In Step S1020, the image-capturing planning path is sent to the processing device, so that the processing device captures images of the regions where the target carriers to be processed are located according to the image-capturing planning path to obtain a plurality of candidate images.

As an example, the processing device is provided with a close-up camera and a long-shot camera. Long-shot image capturing is performed through the long-shot camera, and close-up image capturing is performed through the close-up camera. When performing close-up image capturing for the target carrier to be processed, the close-up camera may only capture an area of 100*100. If the area where the plurality of target carriers to be processed are located is larger, such as 400*400, the close-up camera needs to perform multiple rounds of image capturing according to the image-capturing planning path, and then send the captured candidate images to the upper-level device.

In the embodiment of the present disclosure, after receiving the image-capturing planning path sent by the upper-level device, the processing device controls the close-up camera to perform image capturing according to the image-capturing planning path to obtain a plurality of candidate images. As shown in FIG. 21B, FIG. 21B is a schematic diagram of an image-capturing planning path according to an exemplary embodiment of the present disclosure. For the four target processing patterns shown in FIG. 13C, the upper-level device generates the image-capturing plan as shown in FIG. 21B, that is, first perform image capturing on the target carrier to be processed corresponding to the banana, then the target carrier to be processed corresponding to the watermelon, the target carrier to be processed corresponding to the kiwi fruit, and finally the target carrier to be processed corresponding to the strawberry. After receiving the image-capturing plan, the processing device performs image capturing on the target carriers to be processed corresponding to the banana, watermelon, kiwi fruit, and strawberry in the above order.

In Step S1030, the plurality of candidate images sent by the processing device are received, and the plurality of candidate images are stitched to obtain a close-up image corresponding to the regions where the target carriers to be processed are located.

It can be understood that the close-up image includes all target carriers to be processed. For example, after receiving the plurality of candidate images sent by the processing device, a complete close-up image, that is, a close-up image corresponding to the regions where the plurality of target carriers to be processed are located, can be obtained by stitching the plurality of candidate images.

It should be noted that the content of the relevant steps in the embodiment of the present disclosure is consistent with the content of the corresponding steps recorded in the foregoing embodiment. Therefore, for the detailed description of these steps, refer to the records in the foregoing embodiment, and the embodiment of the present disclosure will not repeat them.

Reference is made to FIG. 20, which is a flowchart of a method for superimposing at least two target processing patterns into processing regions corresponding to respective target carriers to be processed in a close-up image according to an exemplary embodiment of the present disclosure. The method at least includes steps S1110 to S1120, which are described in detail as follows.

In S1110, the position information of the seed processing pattern in the processing region corresponding to each target carrier to be processed is obtained, and the rotation angle corresponding to each target carrier to be processed is obtained.

In S1120, the target processing pattern is placed to the processing region corresponding to each target carrier to be processed based on the position information and the rotation angle.

It can be understood that when placing the carrier to be processed in the processing region of the processing device, there may be a positional offset, resulting in an angular deviation between the obtained image corresponding to the target carrier and the processing pattern in the upper-level device. Therefore, it is necessary to obtain not only the geometric center point but also the rotation angle to make the superimposition of the target processing pattern more accurate.

In some embodiments, before superimposing the target processing pattern into the processing region corresponding to the target carrier to be processed in the close-up image, the seed processing pattern needs to be placed into the processing region to obtain a reference position, that is, the position information of the seed processing pattern in the processing region corresponding to the target carrier to be processed.

In the embodiment of the present disclosure, the carrier to be processed may be placed manually by the user, or placed into the processing region of the processing device by means of a robotic arm or a conveyor belt. The rotation angle of the target carrier to be processed is the offset angle of the target carrier to be processed relative to the reference object. For example, the reference object is placed upright in the editable interface. If the target carrier to be processed is placed at a certain angular deviation when placed into the processing region of the processing device, such as being placed at an inclination of 30°, when superimposing the target processing pattern, the target processing pattern needs to be rotated by 30° and then placed, so that the processing can be more accurate.

For example, with reference to FIG. 21A, after obtaining the close-up image of the target carriers to be processed, it is mapped to the editable interface of the upper-level device. The close-up image includes multiple target carriers to be processed, among which several target carriers to be processed are placed obliquely. Therefore, it is necessary to obtain the respective rotation angle of the image corresponding to the target carrier to be processed in the processing region; then determine the seed processing pattern and a post-replacement pattern as the target processing patterns, rotate the target processing patterns according to the corresponding rotation angles, and then place the target processing patterns into the processing region corresponding to the carriers to be processed in a manner of aligning the center points, thereby realizing the superimposition of the target processing patterns.

It should be noted that the content of the relevant steps in the embodiment of the present disclosure is consistent with the content of the corresponding steps recorded in the foregoing embodiment. Therefore, for the detailed description of these steps, refer to the records in the foregoing embodiment, and the embodiment of the present disclosure will not repeat them.

In Step S8820, in response to a processing operation for the at least two target processing patterns, the processing parameters of the seed processing pattern are obtained.

It can be understood that when the processing device is a laser engraving machine, the processing parameters include laser type, laser power, engraving speed, engraving precision, etc. ; when the processing device is a laser cutting machine, the processing parameters include laser type, laser power, cutting speed, etc.

In the embodiment of the present disclosure, before obtaining the processing parameters of the seed processing pattern, the seed processing pattern needs to be placed into the processing region corresponding to the target carrier to be processed, and the corresponding processing parameters are set. In this way, when processing the target processing pattern, the processing parameters of the seed processing pattern can be reused with one click, without re-setting the corresponding parameters. If the upper-level device records the historical parameters of the seed processing pattern, the historical parameters can also be directly used as the historical processing parameters of the seed processing pattern.

In Step S8830, processing instructions are generated based on the processing parameters and the at least two target processing patterns, and the processing device is controlled based on the processing instructions to perform batch processing on the at least two carriers to be processed according to the at least two target processing patterns.

In an embodiment, it can be understood that since the post-replacement patterns are all obtained based on the seed processing pattern, the post-replacement patterns use the same processing parameters as the seed processing pattern. After obtaining the processing parameters of the seed processing pattern, the processing parameters of all post-replacement patterns are equivalent to being obtained. Then, processing instructions are generated based on the processing parameters and the determined at least two target processing patterns. The upper-level device sends the processing instructions to the processing device, so that the processing device performs batch processing on the at least two carriers to be processed placed on the processing platform of the processing device based on the processing instructions. As an example, the processing instructions here may be in Gcode. The upper-level device is provided with a processing control. In response to a trigger operation for the processing control, the upper-level device generates and issues the processing instructions.

In the embodiment of the present disclosure, as an example, in each processing batch, four carriers can be placed in the processing regions of the processing device. If there are eight target processing patterns, two processing batches are required to complete the processing of all target processing patterns, and the processing parameters of each processing batch are the same.

In some embodiments, if not all of the at least two target processing patterns are superimposed in the current processing batch, the elements in the editable interface are removed, and the remaining target processing patterns that were not superimposed are superimposed into the processing regions corresponding to the carriers in the next processing batch, to continue processing the carriers in the next processing batch, until the target processing patterns are all superimposed.

It can be understood that in the embodiment of the present disclosure, when processing the carriers, it is needed to superimpose the target processing patterns into the processing regions of the carriers on the editable interface, and then process respective carriers according to the target processing patterns superimposed in the processing regions. Therefore, after processing the carriers in the current processing batch, the target processing patterns superimposed on the editable interface need to be removed, that is, the elements in the editable interface are removed. Then, the user can manually place the carriers in the next processing batch, or the carriers in the next processing batch can be placed into the processing regions of the processing device by means of conveyor belt transportation. Then, if not all of the target processing patterns are superimposed, long-shot shooting is continued for the processing regions of the processing device to obtain a long-shot image; then all carriers matching the candidate object in the long-shot image are identified, and the matched carriers are determined as target carriers. Then, the close-up image of the target carriers is obtained. Finally, the remaining target processing patterns that were not superimposed are superimposed into the processing regions corresponding to the carriers in the next processing batch in the close-up image to continue processing the carriers in the next processing batch, until the target processing patterns are all superimposed.

For example, with reference to FIG. 22, FIG. 22 is an application schematic diagram of batch processing by a processing device according to an exemplary embodiment of the present disclosure. In FIG. 22, after obtaining the target processing patterns, the upper-level device sends the target processing patterns to the lower-level device, and the lower-level device processes the plurality of target carriers placed in the processing regions according to the received target processing patterns, thereby realizing automatic multi-batch processing.

For example, 100 target processing patterns are obtained. Target carriers with a same material and size are placed in the processing regions of the processing device, and then the target processing patterns are superimposed into the processing regions corresponding to the target carriers. Then, the XCS in the upper-level device drives the processing device to sequentially process the corresponding processing regions on these target carriers according to the target processing patterns through a series of processes. Due to the limitation of the processing regions of the processing device, for example, the area of the current processing region is 400 mm*300 mm, it is impossible to use up all of these target processing patterns at one time, so they will be used in multiple batches. The number of target processing patterns processed in one batch depends on the number of target carriers placed on the processing region. For example, in the first processing batch, four target carriers are placed in the processing region, so only four target processing patterns can be superimposed. Then, the first processing batch will process these four target processing patterns. After this processing batch is completed, the carriers need to be re-placed until all target processing patterns are superimposed.

In an embodiment of the present disclosure, the method further includes: each target processing pattern corresponding to a processing task; when controlling, based on the processing instructions, the processing device to perform batch processing on the at least two carriers according to the at least two target processing patterns, the method further includes:
in response to a skip operation or a close operation for the processing task, controlling the processing device to skip or stop executing the processing task.

In an embodiment, in a batch processing scenario, the processing process corresponding to each target processing pattern can be regarded as a processing task. For example, if there are four target processing patterns, it is equivalent to four processing tasks. When controlling the processing device to perform batch processing, the editable interface provides controls such as pause processing, reprocessing, skip processing, and close processing for each processing task.

If processing is impossible, the processing effect is poor, or processing is not desirable, the user can click these controls. The upper-level device controls the processing device to pause processing/reprocess/skip processing/close processing for the one or more processing tasks in response to a trigger operation performed on one of the controls with respect to the one or more processing tasks. In this way, more flexibility is provided in the processing process, and user experience is improved.

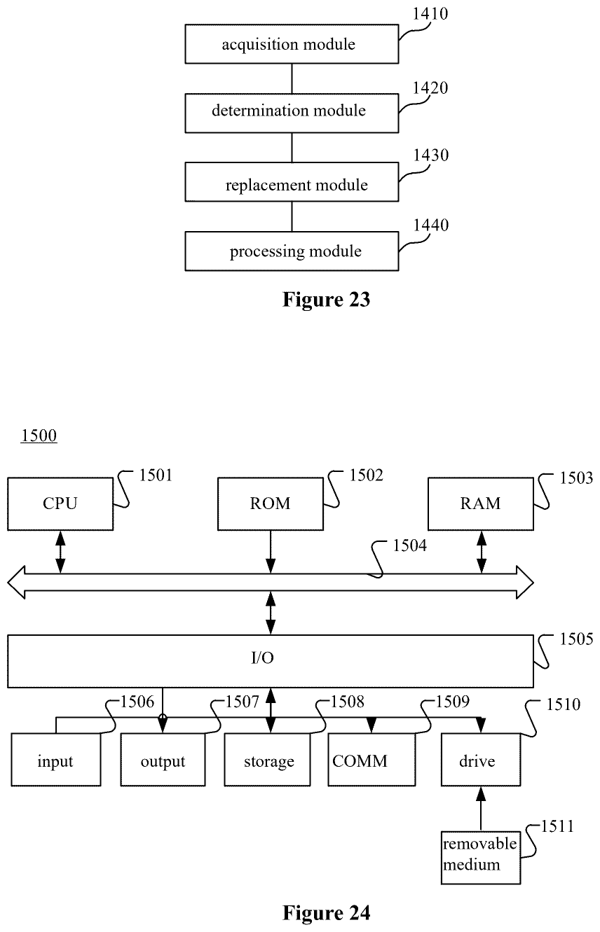

With reference to FIG. 23, in an exemplary embodiment of the present disclosure, a processing control apparatus is provided. The apparatus includes: an acquisition module 1410, a determination module 1420, a replacement module 1430, and a processing module 1440. The acquisition module 1410 is configured to acquire a seed processing pattern; where the seed processing pattern includes at least one processing object. The determination module 1420 is configured to determine an object to be modified from the at least one processing object and obtain at least one replacement object corresponding to the object to be modified. The replacement module 1430 is configured to determine at least two target processing patterns based on the seed processing pattern and the at least one post-replacement pattern obtained by replacing the object to be modified in the seed processing pattern with the at least one replacement object respectively. The processing module 1440 is configured to control the processing device to perform batch processing on at least two carriers according to the at least two target processing patterns.

In some implementations, the seed processing pattern is displayed in the editable interface; the determination module 1420 is configured to determine the object to be modified from the at least one processing object in the following manner, including: when there is one processing object, in response to a variable setting operation for the processing object, determining the processing object set as a variable as the object to be modified; and/or, when there are a plurality of processing objects, in response to a variable setting operation for the plurality of processing objects, determining the processing objects set as variables as the objects to be modified.

In some implementations, the determination module 1420 is configured to obtain at least one replacement object corresponding to the object to be modified in the following manner, including: in response to a confirmation operation for a candidate object, associating the candidate object with the object to be modified to establish an association relationship between the candidate object and the object to be modified; determining the candidate object having the association relationship with the object to be modified as the replacement object corresponding to the object to be modified.

In some implementations, the determination module 1420 is further configured to, before associating the candidate object with the object to be modified in response to the confirmation operation for the candidate object to establish an association relationship between the candidate object and the object to be modified, in response to an import operation for a candidate object document, store the candidate object document in a specified storage area and display the candidate object document in the editable interface; wherein the candidate object document includes a plurality of candidate objects.

In some implementations, the determination module 1420 is further configured to, before associating the candidate object with the object to be modified in response to the confirmation operation for the candidate object to establish an association relationship between the candidate object and the object to be modified, obtain a preset document, wherein the preset document is displayed in the editable interface and includes at least one candidate object; in response to an editing operation for the preset document, obtain an edited preset document; and in response to an import operation for the edited preset document, store the edited preset document in a specified area and display the edited preset document in the editable interface.

In some implementations, the determination module 1420 is further configured to, before obtaining at least one replacement object corresponding to the object to be modified, in response to a trigger operation for a candidate object, add the candidate object to the editable interface; or delete the candidate object.

In some implementations, the processing control apparatus further includes a display module. After determining the object to be modified from the at least one processing object, the display module is configured to:
display the at least one processing object in the editable interface, and perform differentiated display for the determined object to be modified;

where the differentiated display includes at least one of: adding a set identifier at a set position of the object to be modified, performing color differentiated display for the object to be modified, performing line-type differentiated display for the object to be modified, and performing brightness differentiated display for the object to be modified.

In some implementations, after obtaining at least one replacement object corresponding to the object to be modified, the display module is configured to:
in response to a variable setting operation for the object to be modified, display the object to be modified in a first region of the editable interface, and display the object to be modified and at least one replacement object associated with the object to be modified in a second region of the editable interface.

In some implementations, the display module is configured to: in response to a selection operation for one of the at least one replacement object, switch to display the selected replacement object in the first region.

In some implementations, the determination module 1420 is configured to: in response to a trigger operation for a variable setting control in the editable interface, display a pop-up window in the editable interface, the pop-up window including a variable setting page;
in the variable setting page, in response to a variable setting operation for the at least one processing object, determine the processing object set as a variable as the object to be modified;
the pop-up window including a data associating control, and in response to a trigger operation for the data associating control, switch the pop-up window from the variable setting page to a data associating page;
in the data associating page, in response to a candidate object adding operation and/or import operation for the object to be modified, display an added and/or imported candidate object in the data associating page; and
in response to a trigger operation on a confirmation control for the candidate object, determine the candidate object as the replacement object corresponding to the object to be modified.

In some implementations, the processing module 1440 is configured to control the processing device to perform batch processing on the at least two carriers according to the at least two target processing patterns in the following manner, including: superimposing the at least two target processing patterns into the respective processing regions corresponding to the at least two carriers; in response to a processing operation for the at least two target processing patterns, obtaining processing parameters of the seed processing pattern; generating processing instructions based on the processing parameters and the at least two target processing patterns, and controlling, based on the processing instructions, the processing device to perform batch processing on the at least two carriers according to the at least two target processing patterns.

In some implementations, at least two carriers are placed in the processing regions of the processing device; the processing module 1440 is configured to respectively superimpose the at least two target processing patterns into the processing regions corresponding to the at least two carriers in the following manner, including: obtaining a first image captured for the at least two carriers;
determining at least two target carriers based on the first image; and
superimposing the at least two target processing patterns into the processing regions corresponding to respective target carriers.

In some implementations, the first image is a close-up image obtained by close-up image capturing; the processing module 1440 is configured to respectively superimpose the at least two target processing patterns into the processing regions corresponding to the at least two carriers in the following manner, including:
determining all carriers included in the close-up image as target carriers, and displaying the close-up image in the editable interface; and
superimposing the at least two target processing patterns into the processing regions corresponding to respective target carriers in the close-up image.

In some implementations, the first image is a long-shot image obtained by long-shot image capturing; the processing module 1440 is configured to determine at least two target carriers based on the first image and superimpose the at least two target processing patterns into the processing regions corresponding to respective target carriers in the following manner, including:
determining a candidate processing carrier from the at least two carriers according to the long-shot image;
performing similarity comparison between the candidate processing carrier and the remaining other processing carriers among the at least two carriers;
determining one or more of the other processing carriers with similarity exceeding a preset threshold, together with the candidate processing carrier, as target carriers; and
superimposing the at least two target processing patterns into the processing regions corresponding to respective target carriers.

In some implementations, the processing module 1440 is configured to determine the candidate processing carrier from the at least two carriers according to the long-shot image in the following manner, including: performing carrier identification on the long-shot image to obtain an identification frame; in response to a trigger operation for the identification frame, determining the carrier corresponding to the identification frame as the candidate processing carrier.

In some implementations, the processing module 1440 is configured to determine the carrier corresponding to the identification frame as the candidate processing carrier in response to the trigger operation for the identification frame in the following manner, including: if the trigger operation is a confirmation operation for the identification frame, determining the carrier corresponding to the confirmed identification frame as the candidate processing carrier; or, if the trigger operation is an editing operation for the identification frame, determining the carrier corresponding to the edited identification frame as the candidate processing carrier.

In some implementations, the processing module 1440 is configured to superimpose the at least two target processing patterns into the processing regions corresponding to respective target carriers in the following manner, including: obtaining a close-up image obtained by close-up image capturing for the target carrier, and displaying the close-up image in the editable interface, where the processing region included in the close-up image is smaller than the processing region included in the long-shot image; superimposing the at least two target processing patterns into the processing regions corresponding to respective target carriers in the close-up image.

In some implementations, the processing module 1440 is configured to obtain the close-up image obtained by close-up image capturing for the target carrier in the following manner, including: obtaining an image-capturing planning path of the target carrier according to the positions of the target carriers in the processing regions of the processing device; sending the image-capturing planning path to the processing device, so that the processing device captures images of the regions where the target carriers are located according to the image-capturing planning path to obtain a plurality of candidate images; receiving the plurality of candidate images sent by the processing device, and stitching the plurality of candidate images to obtain a close-up image corresponding to the regions where the target carriers are located.

In some implementations, the processing module 1440 is configured to superimpose the at least two target processing patterns into the processing regions corresponding to respective target carriers in the close-up image, including: obtaining the position information of the seed processing pattern in the processing region corresponding to each target carrier, and obtaining the rotation angle corresponding to each target carrier; placing the target processing pattern into the processing region corresponding to each target carrier based on the position information and the rotation angle.

In some implementations, the processing module 1440 is further configured to, when controlling the processing device to perform batch processing on the at least two carriers according to the at least two target processing patterns, if not all of the at least two target processing patterns are superimposed in the current processing batch, remove the elements in the editable interface, and superimpose the remaining target processing patterns that were not superimposed into the processing regions corresponding to the carriers in the next processing batch to continue processing the carriers in the next processing batch, until all the target processing patterns are superimposed.

In some implementations, each target processing pattern corresponds to a processing task. The processing module 1440 is further configured to, when controlling the processing device to perform batch processing on the at least two carriers according to the at least two target processing patterns based on the processing instructions:
in response to a skip operation or a close operation for the processing task, control the processing device to skip or stop executing the processing task.

An embodiment of the present disclosure further provides a processing device, including: a processing head for performing processing on a carrier; a communication component for receiving processing instructions obtained through the steps of the above-mentioned processing control method; a controller for controlling the processing head to perform at least one of laser processing, tool cutting processing, and printing processing on the carrier based on the processing instructions.

An embodiment of the present disclosure further provides a system, including: at least one data processor; and at least one memory storing instructions that, when executed by the at least one data processor, implement the above-mentioned processing control method.

FIG. 24 shows a schematic structural diagram of a computer system applicable for implementing a terminal device according to an embodiment of the present disclosure. It should be noted that the computer system 1500 of the terminal device shown in FIG. 24 is only an example, and should not limit the functions and application scope of the embodiments of the present disclosure.

As shown in FIG. 24, the computer system 1500 includes a central processing unit (CPU) 1501, which can execute various appropriate actions and processes according to programs stored in a read-only memory (ROM) 1502 or programs loaded into a random access memory (RAM) 1503 from a storage part 1508, such as executing the methods described in the above embodiments. In the RAM 1503, various programs and data required for system operation are also stored. The CPU 1501, ROM 1502, and RAM 1503 are connected to each other through a bus 1504. An input/output (I/O) interface 1505 is also connected to the bus 1504.

The following components are connected to the I/O interface 1505: an input part 1506 including a keyboard, a mouse, etc.; an output part 1507 including a cathode ray tube (CRT), a liquid crystal display (LCD), etc., and a speaker, etc.; a storage part 1508 including a hard disk, etc.; and a communication part 1509 including a network interface card such as a local area network (LAN) card, a modem, etc. The communication part 1509 performs communication processing via a network such as the Internet. A drive 1510 is also connected to the I/O interface 1505 as needed. A removable medium 1511, such as a magnetic disk, an optical disk, a magneto-optical disk, a semiconductor memory, etc., is installed on the drive 1510 as needed, so that a computer program read therefrom is installed into the storage part 1508 as needed.

In particular, according to the embodiments of the present disclosure, the processes described above with reference to the flowcharts can be implemented as computer software programs. For example, the embodiments of the present disclosure include a computer program product including a computer program carried on a computer-readable medium, the computer program including computer program code for executing the methods shown in the flowcharts. In such embodiments, the computer program can be downloaded and installed from the network through the communication part 1509, and/or installed from the removable medium 1511. When the computer program is executed by the central processing unit (CPU) 1501, various functions defined in the system of the present disclosure are executed.

It should be noted that the computer-readable medium shown in the embodiments of the present disclosure may be a computer-readable signal medium or a computer-readable storage medium, or any combination of the two. A computer-readable storage medium may be, for example, an electrical, magnetic, optical, electromagnetic, infrared, or semiconductor system, device, or device, or any combination thereof. More specific examples of computer-readable storage media may include, but are not limited to, an electrical connection having one or more wires, a portable computer disk, a hard disk, a random access memory (RAM), a read-only memory (ROM), an erasable programmable read-only memory (EPROM), a flash memory, an optical fiber, a portable compact disk read-only memory (CD-ROM), an optical storage device, a magnetic storage device, or any suitable combination thereof. In the present disclosure, a computer-readable signal medium may include a data signal propagated in baseband or as part of a carrier wave, carrying computer-readable computer program code. Such a propagated data signal may take various forms, including but not limited to electromagnetic signals, optical signals, or any suitable combination thereof. A computer-readable signal medium may also be any computer-readable medium other than a computer-readable storage medium, which can send, propagate, or transmit a program for use by or in connection with an instruction execution system, device, or device. Computer program code contained on a computer-readable medium may be transmitted using any appropriate medium, including but not limited to wireless, wired, etc., or any suitable combination thereof.

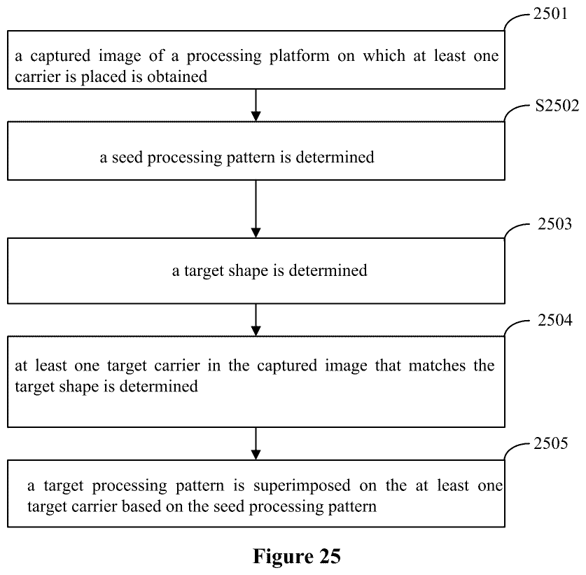

FIG. 25 shows a flowchart of a processing control method according to an exemplary embodiment of the present disclosure. The processing control method may be executed by a processing control device. As shown in the figure, in S2501, a captured image of a processing platform on which at least one carrier is placed is obtained. In S2502, a seed processing pattern is determined. In S2503, a target shape is determined. In S2504, at least one target carrier in the captured image that matches the target shape is determined. In S2505, a target processing pattern is superimposed on the at least one target carrier based on the seed processing pattern.

The captured image may be captured by a camera arranged near the processing platform and then transmitted to the processing control device. Alternatively, the processing control device may obtain a stored captured image of the processing platform from a storage device. One or more carriers are arranged on the processing platform, and patterns may be engraved or formed in other ways on the carriers according to the target processing pattern.

The seed processing pattern is the original basis for subsequent processing on the carrier. The seed processing pattern may be used as the target processing pattern for processing on the carrier. Additionally or alternatively, the seed processing pattern may be edited to form the target processing pattern for processing on the carrier. In batch processing, the target processing patterns to be formed on the at least one carrier may be the same, partially different, or completely different.

The operation of determining the target carrier from the carriers on the processing platform for subsequent processing may be based on the determined target shape, and one or more carriers matching the target shape are determined from the captured image as the target carrier(s). In a possible implementation, a seed carrier may be selected from the carriers on the captured image, the shape of the seed carrier is determined as the target shape, or a preset shape may be input as the target shape. In this case, the carriers determined from the captured image that match the target shape will include the seed carrier and may also include non-seed carriers other than the seed carrier; the seed carrier and the non-seed carriers may be used as candidate target carriers; subsequent processing operations may be performed on at least one of the seed carrier and the non-seed carriers.

It should be understood that matching the target shape may include the case where the shapes are substantially consistent, or the case where the shape difference is less than a certain threshold.

In an exemplary embodiment of the present disclosure, the determined seed carrier already has a processing pattern superimposed thereon. At this time, the processing pattern may be used as the seed processing pattern, so that the target processing pattern may be obtained based on the processing pattern on the seed carrier, and the target processing pattern may be superimposed on at least one non-seed carrier to facilitate subsequent processing operations. Taking a specific embodiment as an example, a captured image is obtained by shooting the processing platform and displayed on the upper-level device. Ten carriers are placed on the processing platform in the captured image, including five square carriers and five circular carriers. For example, one of the circular carriers is selected as the seed carrier, and the seed processing pattern is preset on the circular carrier. Based on the circular carrier serving as the seed carrier, the remaining four circular carriers similar in shape are identified as non-seed carriers. Subsequently, based on the seed processing pattern on the circular carrier serving as the seed carrier, pattern superimposing is performed in batches onto at least one of the remaining four circular carriers serving as non-seed carriers.

In an exemplary embodiment of the present disclosure, there is no pattern on the seed carrier. After obtaining the seed processing pattern, the seed processing pattern may be superimposed on the seed carrier, so that the target processing pattern may be obtained based on the seed processing pattern on the seed carrier, and the target processing pattern may be superimposed on at least one non-seed carrier to facilitate subsequent processing operations. Taking a specific embodiment as an example, a captured image is obtained by shooting the processing platform and displayed on the upper-level device. Ten carriers are placed on the processing platform in the captured image, including five square carriers and five circular carriers. For example, one of the circular carriers is selected as the seed carrier. Based on the circular carrier serving as the seed carrier, the remaining four circular carriers similar in shape are identified as non-seed carriers. Subsequently, the seed processing pattern is superimposed on the circular carrier serving as the seed carrier through an operation in an interactive interface. Based on the seed processing pattern on the circular carrier serving as the seed carrier, pattern superimposing is performed in batches on at least one of the remaining four circular carriers serving as non-seed carriers.

In an exemplary embodiment of the present disclosure, superimposing the target processing pattern on the at least one target carrier based on the seed processing pattern may include: superimposing the seed processing pattern on one of the non-seed carriers. In addition, the seed processing pattern may be processed or edited to obtain the target processing pattern, and then the target processing pattern is superimposed on at least one target carrier among the seed carrier and the non-seed carriers on which the seed processing pattern is not superimposed. Taking a specific embodiment as an example, a captured image is obtained by shooting the processing platform and displayed on the upper-level device. 10 carriers are placed on the processing platform in the captured image, including five square carriers and five circular carriers. For example, one of the circular carriers is selected as the seed carrier. Based on the circular carrier serving as the seed carrier, the remaining four circular carriers similar in shape to it are identified as non-seed carriers. Subsequently, the seed processing pattern is superimposed on one of the circular carriers serving as non-seed carriers through an operation in the interactive interface. Based on the seed processing pattern superimposed on the circular carrier serving as the non-seed carrier, pattern superimposing is performed in batches on at least one of the circular carrier serving as the seed carrier and the remaining three circular carriers serving as non-seed carriers.

In an exemplary embodiment of the present disclosure, superimposing the target processing pattern on the at least one target carrier based on the seed processing pattern may include: obtaining at least two target processing patterns based on the seed processing pattern. One of the target processing patterns is superimposed on one of the target carriers, and then the remaining target processing patterns are superimposed on at least one target carrier on which no target processing pattern is superimposed according to the relative position between the one target processing pattern and the target carrier on which the one target processing pattern is superimposed.

In an exemplary embodiment of the present disclosure, superimposing the target processing pattern on the at least one target carrier based on the seed processing pattern includes: obtaining at least two identical target processing patterns according to the seed processing pattern, where the target processing patterns are the same as or different from the seed processing pattern; and superimposing the target processing patterns on the target carrier. Taking a specific embodiment as an example, a seed processing pattern is imported into the software interactive interface of the upper-level device. A plurality of identical target processing patterns are generated by performing a copy operation on the seed processing pattern, and the plurality of target processing patterns are respectively superimposed on each of the target carriers. In this case, the target processing patterns are the same as the seed processing pattern. Alternatively, in another specific embodiment, a seed processing pattern is imported into the software interactive interface of the upper-level device. The seed processing pattern is edited in the software interactive interface to obtain an updated seed processing pattern. A plurality of identical target processing patterns are generated by performing a copy operation on the updated seed processing pattern, and the plurality of target processing patterns are respectively superimposed on each of the target carriers. In this case, the target processing patterns are different from the seed processing pattern.

In an exemplary embodiment of the present disclosure, in response to determining a plurality of target carriers, superimposing the target processing pattern on the at least one target carrier based on the seed processing pattern includes: obtaining a plurality of target processing patterns according to the seed processing pattern, where at least two of the plurality of target processing patterns are different; and superimposing the target processing patterns on the plurality of target carriers. Taking a specific embodiment as an example, after a user imports a seed processing pattern into the software interactive interface of the upper-level device, a pattern group is generated based on the seed processing pattern. The composition of the pattern group includes but is not limited to the following cases: (1) a plurality of completely different patterns; (2) a plurality of patterns including at least two different patterns, and the remaining patterns are the same. Subsequently, each pattern in the pattern group is used as a target processing pattern and superimposed on the target carrier. Different from the previous embodiment, in this embodiment, the generated plurality of target patterns include at least two different patterns.

It should be noted that the various embodiments may be combined with each other unless there is a conflict. Some physical implementations will be exemplarily described below in a specific processing operation environment. It should be understood that these specific implementations are only illustrative and are not intended to limit the scope of the present disclosure.

The following will exemplarily describe in detail the scheme for batch processing a plurality of carriers on a processing platform. Assume that there are at least carriers A, B, C, and D on the processing platform. It should be understood that the present invention is not limited to the number, shape, positional relationship, operation order, etc. described herein.

For example, assume there are four carriers A, B, C, and D with a consistent shape. The user superimposes a seed processing pattern a (without any modification) on carrier A in advance. The four carriers are placed on the processing platform. The device captures the contour and pattern features of carrier A through image recognition technology, determines carrier A as the seed carrier, and identifies the remaining target carriers B, C, and D. The user sets a one-click superimposing instruction on the software interactive interface, and then the target processing pattern is superimposed on the remaining target carriers B, C, and D in the software interactive interface; or the user sets a batch processing instruction as “superimpose pattern a on carriers B and C”, and based on pattern a on the seed carrier A, pattern a is superimposed on carriers B and C in the software interactive interface. After the pattern is superimposed on all carriers to be processed, a “Start Processing” button in the software interactive interface is clicked. The upper-level device generates a processing plan file and sends it to the processing device. The processing device performs batch processing on the plurality of carriers to be processed through laser printing, engraving, or other technologies.

For another example, the user places four carriers A, B, C, and D with similar shapes (for example, the shape difference is less than a certain threshold) on the processing platform, selects carrier A, and extracts the shape feature of carrier A as the target shape. The processing device identifies all target carriers A, B, C, and D based on the target shape. After the user imports the seed processing pattern a, the pattern generation module of the processing device performs derivative design on the seed processing pattern a to generate a pattern group (including pattern a1, pattern b, pattern b, and pattern d, where a1 is a color-modified version of a). The user sets a one-click filling instruction on the software interactive interface, and then pattern a1, pattern b, pattern b, and pattern d are superimposed on target carriers A, B, C, and D respectively in the software interactive interface. Alternatively, the user instructs “superimpose pattern a1 on carrier B, superimpose pattern b on carriers A and C, and superimpose pattern d on carrier D”. The device first superimposes pattern a1 on carrier B, then uses patterns a1, b, and d as benchmarks to complete the batch superimposition of different patterns on carriers A, C, and D respectively, and finally realizes the differentiated pattern batch processing of the four carriers.

Those skilled in the art can adjust the carrier selection, pattern modification method, number of carriers for batch superimposition, and composition form of the pattern group in the above embodiments according to actual processing needs. All modified implementations based on the core concept of the present invention fall within the protection scope of the present disclosure.

According to an embodiment, a processing control method includes, obtaining a captured image of a processing platform on which at least one carrier is placed; determining a seed processing pattern; determining a target shape; determining at least one target carrier in the captured image that matches the target shape; and superimposing a target processing pattern on the at least one target carrier based on the seed processing pattern.

For example, determining the target shape and determining the at least one target carrier in the captured image that matches the target shape comprises: selecting a seed carrier from the captured image, and determining a shape of the seed carrier as the target shape; determining at least one non-seed carrier in the captured image that matches the target shape; and using at least one of the seed carrier and the non-seed carrier as the at least one target carrier.

For example, the seed carrier has the seed processing pattern superimposed thereon, and superimposing the target processing pattern on the at least one target carrier based on the seed processing pattern comprises: obtaining the target processing pattern based on the seed processing pattern on the seed carrier, and superimposing the target processing pattern on the at least one non-seed carrier.

For example, superimposing the target processing pattern on the at least one target carrier based on the seed processing pattern comprises: superimposing the seed processing pattern on the seed carrier; obtaining the target processing pattern based on the seed processing pattern; and superimposing the target processing pattern on the at least one non-seed carrier.

For example, superimposing the target processing pattern on the at least one target carrier based on the seed processing pattern comprises: superimposing the seed processing pattern on one of the at least one non-seed carrier; obtaining the target processing pattern based on the seed processing pattern; and superimposing the target processing pattern on at least one target carrier among the seed carrier and the non-seed carriers on which the seed processing pattern is not superimposed.

For example, superimposing the target processing pattern on the at least one target carrier based on the seed processing pattern comprises: obtaining at least two target processing patterns based on the seed processing pattern; superimposing one of the target processing patterns on one of the target carriers; and superimposing remaining target processing patterns on at least one target carrier on which no target processing pattern is superimposed according to a relative position between the one of the target processing patterns and the target carrier on which the one of the target processing patterns is superimposed.

For example, superimposing the target processing pattern on the at least one target carrier based on the seed processing pattern comprises: obtaining at least two identical target processing patterns according to the seed processing pattern, wherein the target processing patterns are the same as or different from the seed processing pattern; and superimposing the target processing patterns on the target carrier.

For example, in response to determining a plurality of target carriers, superimposing the target processing pattern on the at least one target carrier based on the seed processing pattern comprises: obtaining a plurality of target processing patterns according to the seed processing pattern, wherein at least two of the plurality of target processing patterns are different from each other; and superimposing the target processing patterns on the plurality of target carriers.

For example, the seed processing pattern comprises at least one processing object; and the method further comprises: determining an object to be modified from the at least one processing object, and obtaining at least one replacement object corresponding to the object to be modified; determining at least two target processing patterns based on at least one post-replacement image obtained by replacing the object to be modified in the seed processing pattern with the at least one replacement object; and controlling the processing device to perform processing on at least two of the plurality of target carriers according to the at least two target processing patterns.

For example, the seed processing pattern is displayed in an editable interface; determining the object to be modified from the at least one processing object comprises: in a case that the seed processing pattern comprises one processing object, in response to a variable setting operation for the processing object, determining the processing object, which was set as a variable, as the object to be modified; and/or, in a case that the seed processing pattern comprises a plurality of processing objects, in response to a variable setting operation for at least one of the plurality of processing objects, determining the processing object which was set as a variable as the object to be modified.

For example, obtaining the at least one replacement object corresponding to the object to be modified comprises: in response to a confirmation operation for a candidate object, associating the candidate object with the object to be modified to establish an association relationship between the candidate object and the object to be modified; and determining the candidate object having the association relationship with the object to be modified as the replacement object corresponding to the object to be modified.

For example, before associating the candidate object with the object to be modified in response to the confirmation operation for the candidate object to establish the association relationship between the candidate object and the object to be modified, the method further comprises: in response to an import operation for a candidate object document, displaying the candidate object document in the editable interface; wherein the candidate object document comprises a plurality of candidate objects; or, obtaining a preset document; wherein the preset document is displayed in the editable interface and includes at least one candidate object; and in response to an import operation for the candidate object document, displaying the candidate object document in the editable interface, wherein the candidate objects of the candidate object document and the at least one candidate object of the preset document are simultaneously displayed in the editable interface.

For example, after determining the object to be modified from the at least one processing object, the method further comprises: displaying the at least one processing object in the editable interface, and performing differentiated display for the determined object to be modified; wherein the differentiated display comprises at least one of: adding a set identifier at a set position of the object to be modified, performing color differentiated display for the object to be modified, performing line-type differentiated display for the object to be modified, and performing brightness differentiated display for the object to be modified.

For example, after obtaining the at least one replacement object corresponding to the object to be modified, the method further comprises: in response to a variable setting operation for the object to be modified, displaying the object to be modified in a first region of the editable interface, and displaying the object to be modified and the at least one replacement object associated with the object to be modified in a second region of the editable interface.

For example, determining the object to be modified from the at least one processing object and obtaining the at least one replacement object corresponding to the object to be modified comprises: in response to a trigger operation for a variable setting control in the editable interface, displaying a pop-up window in the editable interface, the pop-up window comprising a variable setting page; in the variable setting page, in response to a variable setting operation for the at least one processing object, determining the processing object set as a variable as the object to be modified; the pop-up window comprising a data associating control, and in response to a trigger operation for the data associating control, switching the pop-up window from the variable setting page to a data associating page; in the data associating page, in response to a candidate object adding operation and/or import operation for the object to be modified, displaying an added and/or imported candidate object in the data associating page; and in response to a trigger operation on a confirmation control for the candidate object, determining the candidate object as the replacement object corresponding to the object to be modified.

For example, after superimposing the target processing pattern on the at least one target carrier based on the seed processing pattern, the method further comprises: in response to a processing operation for at least two carriers with a same shape on the processing platform, obtaining the target processing pattern and processing parameters corresponding to the target processing pattern, and generating processing instructions; controlling, based on the processing instructions, the processing device to perform processing on the at least two carriers with the same shape on the processing platform according to the target processing pattern.

For example, when controlling the processing device to perform batch processing on the at least two carriers with the same shape on the processing platform based on the processing instructions, the method further comprises: if the target processing pattern is in a number greater than the number of carriers with the same shape in a current processing batch, superimposing remaining target processing patterns on the carriers with the same shape in a next processing batch to continue processing the carriers in the next processing batch, until the target processing patterns are all used.

For example, determining the at least one target carrier in the captured image that matches the target shape comprises: obtaining a pixel distribution of the at least one carrier in the captured image, and determining the at least one target carrier according to the pixel distribution of the at least one carrier.

For example, determining the at least one target carrier according to the pixel distribution of the at least one carrier comprises: generating pixel distributions of modified seed carriers based on the pixel distribution of the seed carrier, wherein the modified seed carriers are obtained by rotating the seed carrier by a set of preset angles; and performing a similarity matching between the at least one carrier and the modified seed carriers based on the pixel distribution of the at least one carrier and the pixel distributions of the modified seed carriers, to determine the at least one target carrier.

For example, the pixel distribution of the at least one carrier is determined in a preset coordinate system, and determining the at least one target carrier according to the pixel distribution of the at least one carrier further comprises: performing the similarity matching between the at least one carrier and the modified seed carriers according to the pixel distribution of the at least one carrier and the pixel distributions of the modified seed carriers in the preset coordinate system to determine a rotation angle of the target carrier relative to the seed carrier.

For example, superimposing the target processing pattern on the at least one target carrier comprises: determining a position of the target carrier in the preset coordinate system; superimposing the target processing pattern on the at least one target carrier based on the position of the target carrier in the preset coordinate system and the rotation angle.

For example, superimposing the target processing pattern on the at least one target carrier based on the position of the target carrier in the preset coordinate system and the rotation angle comprises: obtaining a translation distance of the target carrier relative to the seed carrier according to the pixel distribution of the target carrier in the preset coordinate system; and superimposing the target processing pattern on the at least one target carrier according to the translation distance and the rotation angle of the target carrier and a position where the target processing pattern on the seed carrier is located in the preset coordinate system.

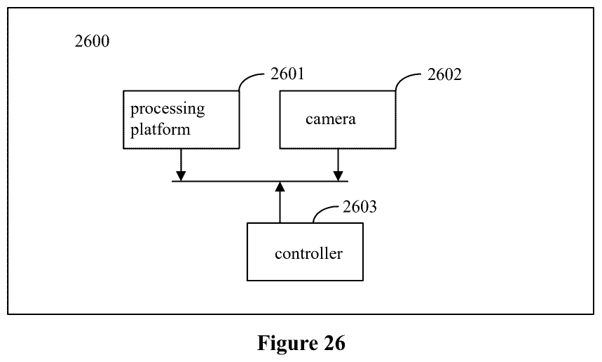

FIG. 26 shows a block diagram of a processing device according to an exemplary embodiment of the present disclosure. As shown in the figure, the processing device 2600 includes a processing platform 2601 for placing at least one carrier, and a camera 2602. The camera 2602 is used for capturing an image of the at least one carrier placed on the processing platform 2601. The processing device 2600 further includes a controller 2603 configured to: determine a seed processing pattern, determine a target shape, determine at least one target carrier in the captured image that matches the target shape; and superimpose a target processing pattern on the at least one target carrier based on the seed processing pattern.

In an embodiment of the present disclosure, a system is provided, including: at least one processor; at least one non-volatile computer-readable storage medium; and program instructions stored on the non-volatile computer-readable storage medium and executable by the processor, such that the system is configured to: obtain a captured image of a processing platform on which at least one carrier is placed; determine a seed processing pattern; determine a target shape; determine at least one target carrier in the captured image that matches the target shape; and superimpose a target processing pattern on the at least one target carrier based on the seed processing pattern.

In an embodiment of the present disclosure, a non-volatile computer-readable storage medium is provided, including a program that, when executed by a processor, causes the processor to perform: obtaining a captured image of a processing platform on which at least one carrier is placed; determining a seed processing pattern; determining a target shape; determining at least one target carrier in the captured image that matches the target shape; and superimposing a target processing pattern on the at least one target carrier based on the seed processing pattern.

The present disclosure is described with reference to flowcharts and/or block diagrams of methods, devices (systems), and computer program products according to the present disclosure. It should be understood that each process and/or block in the flowcharts and/or block diagrams, and combinations of processes and/or blocks in the flowcharts and/or block diagrams, can be implemented by computer program instructions. These computer program instructions may be provided to a processor of a general-purpose computer, a special-purpose computer, an embedded processor, or other programmable data processing devices to produce a machine, such that the instructions executed by the processor of the computer or other programmable data processing devices produce an apparatus for implementing the functions specified in one or more processes of the flowcharts and/or one or more blocks of the block diagrams.

These computer program instructions may also be stored in a computer-readable memory that can direct a computer or other programmable data processing devices to operate in a specific manner, such that the instructions stored in the computer-readable memory produce an article of manufacture including an instruction apparatus that implements the functions specified in one or more processes of the flowcharts and/or one or more blocks of the block diagrams.

It should be noted that the embodiments of the present disclosure and the features in the embodiments may be combined with each other if there is no conflict.

The structures, proportions, sizes, etc. shown in the drawings of this specification are only used to match the contents disclosed in the specification for those skilled in the art to understand and read, and are not used to limit the restrictive conditions that can be implemented in the present disclosure. Therefore, they have no technical substantive significance. Any structural modification, proportional relationship change, or size adjustment should still fall within the scope of the technical content disclosed in the present disclosure without affecting the effects and purposes that can be achieved by the present disclosure.

The above are only specific implementations of the present invention, but the protection scope of the present invention is not limited thereto. Any changes or substitutions that can be easily conceived by those skilled in the art within the technical scope disclosed in the present invention shall fall within the protection scope of the present invention. Therefore, the protection scope of the present invention shall be subject to the protection scope of the claims.

What is claimed is:

1. A processing control method, comprising:
obtaining a captured image of a processing platform on which at least one carrier is placed;
determining a seed processing pattern;
determining a target shape;
determining at least one target carrier in the captured image that matches the target shape; and
superimposing a target processing pattern on the at least one target carrier based on the seed processing pattern.

2. The processing control method according to claim 1, wherein determining the target shape and determining the at least one target carrier in the captured image that matches the target shape comprises:
selecting a seed carrier from the captured image, and determining a shape of the seed carrier as the target shape;
determining at least one non-seed carrier in the captured image that matches the target shape; and
using at least one of the seed carrier and the non-seed carrier as the at least one target carrier.

3. The processing control method according to claim 2, wherein the seed carrier has the seed processing pattern superimposed thereon, and superimposing the target processing pattern on the at least one target carrier based on the seed processing pattern comprises:
obtaining the target processing pattern based on the seed processing pattern on the seed carrier, and superimposing the target processing pattern on the at least one non-seed carrier.

4. The processing control method according to claim 2, wherein superimposing the target processing pattern on the at least one target carrier based on the seed processing pattern comprises:
superimposing the seed processing pattern on the seed carrier;
obtaining the target processing pattern based on the seed processing pattern; and
superimposing the target processing pattern on the at least one non-seed carrier.

5. The processing control method according to claim 2, wherein superimposing the target processing pattern on the at least one target carrier based on the seed processing pattern comprises:
superimposing the seed processing pattern on one of the at least one non-seed carrier;
obtaining the target processing pattern based on the seed processing pattern; and
superimposing the target processing pattern on at least one target carrier among the seed carrier and the non-seed carriers on which the seed processing pattern is not superimposed.

6. The processing control method according to claim 1, wherein superimposing the target processing pattern on the at least one target carrier based on the seed processing pattern comprises:
obtaining at least two target processing patterns based on the seed processing pattern;
superimposing one of the target processing patterns on one of the target carriers; and
superimposing remaining target processing patterns on at least one target carrier on which no target processing pattern is superimposed according to a relative position between the one of the target processing patterns and the target carrier on which the one of the target processing patterns is superimposed.

7. The processing control method according to claim 1, wherein superimposing the target processing pattern on the at least one target carrier based on the seed processing pattern comprises:
obtaining at least two identical target processing patterns according to the seed processing pattern, wherein the target processing patterns are the same as or different from the seed processing pattern; and
superimposing the target processing patterns on the target carrier.

8. The processing control method according to claim 1, wherein in response to determining a plurality of target carriers, superimposing the target processing pattern on the at least one target carrier based on the seed processing pattern comprises:
obtaining a plurality of target processing patterns according to the seed processing pattern, wherein at least two of the plurality of target processing patterns are different from each other; and
superimposing the target processing patterns on the plurality of target carriers.

9. The processing control method according to claim 8, wherein the seed processing pattern comprises at least one processing object; and the method further comprises:
determining an object to be modified from the at least one processing object, and obtaining at least one replacement object corresponding to the object to be modified;
determining at least two target processing patterns based on at least one post-replacement image obtained by replacing the object to be modified in the seed processing pattern with the at least one replacement object; and
controlling the processing device to perform processing on at least two of the plurality of target carriers according to the at least two target processing patterns.

10. The processing control method according to claim 9, wherein the seed processing pattern is displayed in an editable interface;
determining the object to be modified from the at least one processing object comprises:
in a case that the seed processing pattern comprises one processing object, in response to a variable setting operation for the processing object, determining the processing object, which was set as a variable, as the object to be modified;
and/or,
in a case that the seed processing pattern comprises a plurality of processing objects, in response to a variable setting operation for at least one of the plurality of processing objects, determining the processing object which was set as a variable as the object to be modified.

11. The processing control method according to claim 9, wherein obtaining the at least one replacement object corresponding to the object to be modified comprises:
in response to a confirmation operation for a candidate object, associating the candidate object with the object to be modified to establish an association relationship between the candidate object and the object to be modified; and
determining the candidate object having the association relationship with the object to be modified as the replacement object corresponding to the object to be modified.

12. The processing control method according to claim 11, wherein before associating the candidate object with the object to be modified in response to the confirmation operation for the candidate object to establish the association relationship between the candidate object and the object to be modified, the method further comprises:
in response to an import operation for a candidate object document, displaying the candidate object document in the editable interface; wherein the candidate object document comprises a plurality of candidate objects;
or, obtaining a preset document; wherein the preset document is displayed in the editable interface and includes at least one candidate object; and
in response to an import operation for the candidate object document, displaying the candidate object document in the editable interface, wherein the candidate objects of the candidate object document and the at least one candidate object of the preset document are simultaneously displayed in the editable interface.

13. The processing control method according to claim 9, wherein after determining the object to be modified from the at least one processing object, the method further comprises:
displaying the at least one processing object in the editable interface, and performing differentiated display for the determined object to be modified; and
wherein the differentiated display comprises at least one of: adding a set identifier at a set position of the object to be modified, performing color differentiated display for the object to be modified, performing line-type differentiated display for the object to be modified, and performing brightness differentiated display for the object to be modified.

14. The processing control method according to claim 13, wherein after obtaining the at least one replacement object corresponding to the object to be modified, the method further comprises:
in response to a variable setting operation for the object to be modified, displaying the object to be modified in a first region of the editable interface, and displaying the object to be modified and the at least one replacement object associated with the object to be modified in a second region of the editable interface.

15. The processing control method according to claim 9, wherein determining the object to be modified from the at least one processing object and obtaining the at least one replacement object corresponding to the object to be modified comprises:
in response to a trigger operation for a variable setting control in the editable interface, displaying a pop-up window in the editable interface, the pop-up window comprising a variable setting page;
in the variable setting page, in response to a variable setting operation for the at least one processing object, determining the processing object set as a variable as the object to be modified;
the pop-up window comprising a data associating control, and in response to a trigger operation for the data associating control, switching the pop-up window from the variable setting page to a data associating page;
in the data associating page, in response to a candidate object adding operation and/or import operation for the object to be modified, displaying an added and/or imported candidate object in the data associating page; and
in response to a trigger operation on a confirmation control for the candidate object, determining the candidate object as the replacement object corresponding to the object to be modified.

16. The processing control method according to claim 1, wherein after superimposing the target processing pattern on the at least one target carrier based on the seed processing pattern, the method further comprises:
in response to a processing operation for at least two carriers with a same shape on the processing platform, obtaining the target processing pattern and processing parameters corresponding to the target processing pattern, and generating processing instructions; and
controlling, based on the processing instructions, the processing device to perform processing on the at least two carriers with the same shape on the processing platform according to the target processing pattern.

17. The processing control method according to claim 16, wherein when controlling the processing device to perform batch processing on the at least two carriers with the same shape on the processing platform based on the processing instructions, the method further comprises:
if the target processing pattern is in a number greater than the number of carriers with the same shape in a current processing batch, superimposing remaining target processing patterns on the carriers with the same shape in a next processing batch to continue processing the carriers in the next processing batch, until the target processing patterns are all used.

18. The processing control method according to claim 2, wherein determining the at least one target carrier in the captured image that matches the target shape comprises:
obtaining a pixel distribution of the at least one carrier in the captured image, and
determining the at least one target carrier according to the pixel distribution of the at least one carrier.

19. The processing control method according to claim 18, wherein determining the at least one target carrier according to the pixel distribution of the at least one carrier comprises:
generating pixel distributions of modified seed carriers based on the pixel distribution of the seed carrier, wherein the modified seed carriers are obtained by rotating the seed carrier by a set of preset angles; and
performing a similarity matching between the at least one carrier and the modified seed carriers based on the pixel distribution of the at least one carrier and the pixel distributions of the modified seed carriers, to determine the at least one target carrier.

20. The processing control method according to claim 19, wherein the pixel distribution of the at least one carrier is determined in a preset coordinate system, and determining the at least one target carrier according to the pixel distribution of the at least one carrier further comprises:
performing the similarity matching between the at least one carrier and the modified seed carriers according to the pixel distribution of the at least one carrier and the pixel distributions of the modified seed carriers in the preset coordinate system to determine a rotation angle of the target carrier relative to the seed carrier.

21. The processing control method according to claim 20, wherein superimposing the target processing pattern on the at least one target carrier comprises:
determining a position of the target carrier in the preset coordinate system; and
superimposing the target processing pattern on the at least one target carrier based on the position of the target carrier in the preset coordinate system and the rotation angle.

22. The processing control method according to claim 21, wherein superimposing the target processing pattern on the at least one target carrier based on the position of the target carrier in the preset coordinate system and the rotation angle comprises:
obtaining a translation distance of the target carrier relative to the seed carrier according to the pixel distribution of the target carrier in the preset coordinate system; and
superimposing the target processing pattern on the at least one target carrier according to the translation distance and the rotation angle of the target carrier and a position where the target processing pattern on the seed carrier is located in the preset coordinate system.

23. A processing device, comprising:
a processing platform for placing at least one carrier;
a camera for capturing an image of the at least one carrier placed on the processing platform; and
a controller configured to:
determine a seed processing pattern;
determine a target shape;
determine at least one target carrier in the captured image that matches the target shape; and
superimpose a target processing pattern on the at least one target carrier based on the seed processing pattern.

24. A system, comprising:
at least one processor;
at least one non-volatile computer-readable storage medium; and
program instructions stored on the non-volatile computer-readable storage medium and executable by the processor, enabling the system to:
obtain a captured image of a processing platform on which at least one carrier is placed;
determine a seed processing pattern;
determine a target shape;
determine at least one target carrier in the captured image that matches the target shape; and
superimpose a target processing pattern on the at least one target carrier based on the seed processing pattern.

25. A non-volatile computer-readable storage medium, comprising a program that, when executed by a processor, causes the processor to perform:
obtaining a captured image of a processing platform on which at least one carrier is placed;
determining a seed processing pattern;
determining a target shape;
determining at least one target carrier in the captured image that matches the target shape; and
superimposing a target processing pattern on the at least one target carrier based on the seed processing pattern.
